(19) United States
(12) Patent Application Publication
(10) Pub. No.: US 2013/0315260 A1
(43) Pub. Date: Nov. 28, 2013

(54) Flow-Based TCP

(71) Applicant: BROCADE COMMUNICATIONS SYSTEMS, INC., (US)

(72) Inventors: Siva Adiraju, Fremont, CA (US); Ryan Hegland, Champlin, MN (US); Isaac Larson, Minneapolis, MN (US); Andy Dooley, Rogers, MN (US)

(73) Assignee: BROCADE COMMUNICATIONS SYSTEMS, INC., San Jose, CA (US)

(21) Appl. No.: 13/678,032

(22) Filed: Nov. 15, 2012

Related U.S. Application Data
(60) Provisional application No. 61/567,288, filed on Dec. 6, 2011.

(51) Int. Cl. H04L 12/863

(52) U.S. Cl. CPC H04L 47/62
USPC 370/415

(57) ABSTRACT

A system and method for sharing a WAN TCP tunnel between multiple flows without having head of the line blocking problem is disclosed. When a complete but out of order PDU is stuck behind an incomplete PDU in a TCP tunnel, the complete but out of order PDU is removed from the tunnel. To do that, first the boundaries of the PDUs of the different flows are preserved and the TCP receive window advertisement is increased. The receive window is opened when initially receiving out-of-order data. As out-of-order complete PDUs are pulled out of the receive queue, to address double counting, place holders are used in the receive queue to indicate data that was in the queue. As out-of-order data PDUs are pulled out of the queue the window advertisement is increased. This keeps the sending side from running out of TX window and stopping transmission of new data.

### CROSS REFERENCE TO RELATED APPLICATIONS

This application claims the benefit under 35 U.S.C. §119(e) of U.S. Provisional Patent Application Ser. No. 61/567,288 entitled “Flow-based TCP,” filed Dec. 6, 2011, which is hereby incorporated by reference.

This application is also related to U.S. patent application Ser. Nos. ______, entitled “Lossless Connection Failover for Single Devices,” Attorney Docket No. 112-0690US, ______, entitled “TCP Connection Relocation,” Attorney Docket No. 112-0691US, and ______, entitled “Lossless Connection Failover for Mirrored Devices,” Attorney Docket No. 112-0690US1, all three filed concurrently herewith, which are hereby incorporated by reference.

### TECHNICAL FIELD

The present invention relates to the field of computer networking, and in particular to long distance or Wide Area Network (WAN) communications.

### BACKGROUND

In WAN optimization products, and some other products, there is a need to tunnel multiple flows in the same TCP tunnel. Carrying multiple LAN TCP connections over one WAN TCP connection can cause head of line blocking. Head of line blocking occurs if there is a frame loss for one of the data flows. In this case, the flow with the missing frame gets stuck in the TCP tunnel until the lost frame is retransmitted. Flows that follow the missing frame flow will be impacted by this as they will also not be delivered until the first flow has passed through the TCP tunnel. This results in unnecessary time delays.

One way to avoid this problem is to establish a WAN TCP connection for each LAN TCP connection. However, this requires many resources and is very inefficient.

Thus, what is needed is an efficient method for carrying multiple LAN TCP connections over one WAN TCP connection while avoiding a head of line blocking problem.

### SUMMARY OF THE INVENTION

The preferred embodiment uses a method to share a TCP tunnel between multiple flows without having head of the line blocking problem. When a complete but out of order PDU is stuck behind an incomplete PDU in a TCP tunnel, the complete but out of order PDU is removed from the tunnel. To do that, first, the boundaries of the PDUs of the different flows are preserved and the TCP receive window advertisement is increased. The receive window is opened when initially receiving out-of-order data. As out-of-order complete PDUs are pulled out of the receive queue, to address double counting, place holders are used in the receive queue to indicate data that was in the queue. As out-of-order data PDUs are pulled out of the queue the window advertisement is increased. This keeps the sending side from running out of TX window and stopping transmission of new data.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a block diagram of an embodiment two connected data centers according to one embodiment of the present invention.

FIG. 2 illustrates an exemplary network architecture which includes CNE devices for facilitate cross-data-center communications, in accordance with one embodiment of the present invention.

FIG. 3 illustrates an exemplary implementation of CNE-enabled VCSs, in accordance with one embodiment of the present invention.

FIG. 4A presents a diagram illustrating how CNE devices handle broadcast, unknown unicast, and multicast (BUM) traffic across data centers, in accordance with one embodiment of the present invention.

FIG. 4B presents a diagram illustrating how CNE devices handle unicast traffic across data centers, in accordance with one embodiment of the present invention.

FIG. 5 illustrates an example where two CNE devices are used to construct a vLAG, in accordance with an embodiment of the present invention.

FIG. 6 is a block diagram of an embodiment of an LDCM appliance according to one embodiment of the present invention.

FIG. 7 is a block diagram of the data centers of FIG. 1 modified to operate according to one embodiment of the present invention.

FIGS. 8A and 8B are block diagrams of the functional blocks of the LDCM appliance of FIG. 6.

FIG. 9 is a ladder diagram of Hyper-TCP session create and close processes according to one embodiment of the present invention.

FIG. 10 is a ladder diagram of Hyper-TCP data transfer operations according to one embodiment of the present invention.

FIG. 11 is a block diagram illustrating the operation of Hyper-TCP according to one embodiment of the present invention.

FIGS. 12A-12O illustrate a flow of PDUs over a single TCP connection in the WAN according to one embodiment of the present invention.

FIG. 13 is a representation of a TCP PDU for reassembly according to one embodiment of the present invention.

FIG. 14 is a representation of a TCP PDU placeholder according to one embodiment of the present invention.

FIG. 15 is a representation of a segmented PDU header according to one embodiment of the present invention.

FIG. 16 is a representation of an example RX window according to one embodiment of the present invention.

FIG. 17 is a graph of the advertised window sizes for Table 3.

FIG. 18 is a graph of bytes processed by the upper layer for Table 3.

### DETAILED DESCRIPTION OF THE PREFERRED EMBODIMENTS

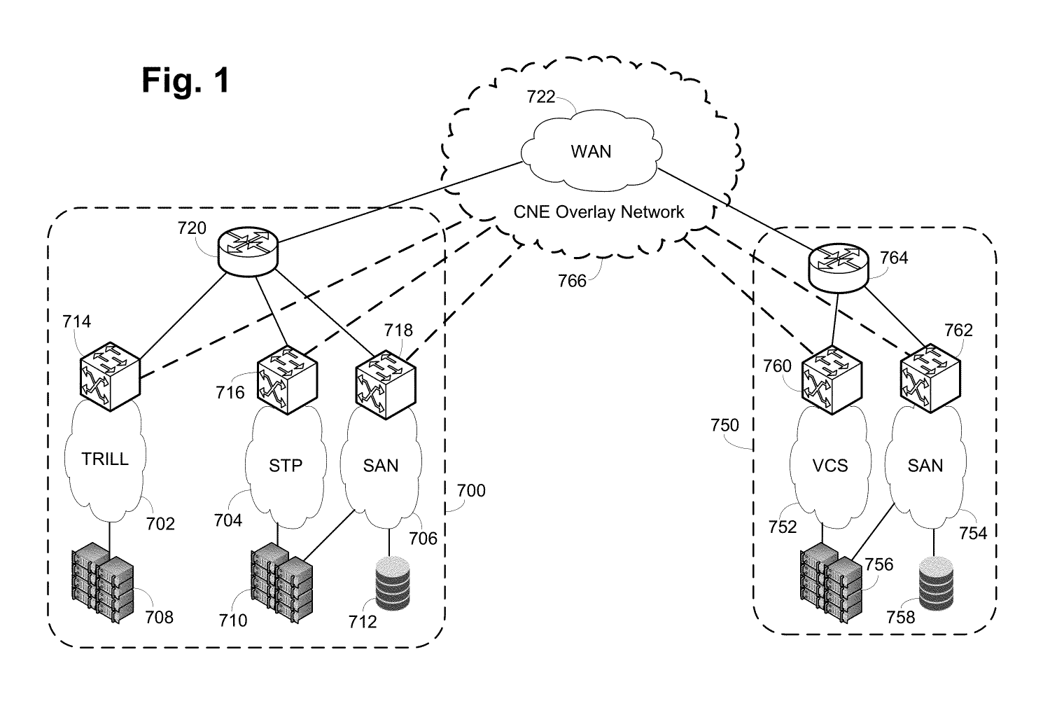

Referring to FIG. 1, a network illustrating portions according to the present invention is shown. A first data center 700 is shown having three separate internal networks, a TRILL network 702, a normal Ethernet spanning tree protocol (STP) network 704 and a storage area network (SAN) 706. Application servers 708 are connected to the TRILL network 702, while application servers 710 are connected to the STP network 704 and the SAN 706. Storage 712 is shown connected to the SAN 706. Each of the networks 702, 704 and 706 has a converged network extension (CNE) device 714, 716, 718 connected to it. The CNE devices 714, 716, 718 are connected to a router 720, which in turn is connected to a WAN 722. A second data center 750 is similar, having a VCS Ethernet fabric network 752 and a SAN 754. Application servers 756 are connected to each network 752 and 754, with storage 758 connected to the SAN 754. CNE devices 760 and 762 are each connected to a network 752 and 754, respectively and to a router 764, which is also connected to the WAN 722 to allow the data centers 700 and 750 to communicate. The operation of the CNE devices 714-718 and 760-762 result in an effective CNE overlay network 766, with virtual links from each CNE device to the CNE overlay network 766.

One goal of the embodiments of the present invention is to extend a VCS and TRILL network across data centers and meet the scalability requirements needed by the deployments. A CNE device can be implemented in a two-box solution, wherein one box is capable of L2/L3/FCoE switching and is part of the VCS, and the other facilitates the WAN tunneling to transport Ethernet and/or FC traffic over WAN. The CNE device can also be implemented in a one-box solution, wherein a single piece of network equipment combines the functions of L2/L3/FCoE switching and WAN tunneling.

VCS as a layer-2 switch uses TRILL as its inter-switch connectivity and delivers a notion of single logical layer-2 switch. This single logical layer-2 switch delivers a transparent LAN service. All the edge ports of VCS support standard protocols and features like Link Aggregation Control Protocol (LACP), Link Layer Discovery Protocol (LLDP), VLANs, MAC learning, and the like. VCS achieves a distributed MAC address database using Ethernet Name Service (eNS) and attempts to avoid flooding as much as possible. VCS also provides various intelligent services, such as virtual link aggregation group (vLAG), advance port profile management (APPM), End-to-End FCoE, Edge-Loop-Detection, and the like. More details on VCS are available in U.S. patent application Ser. Nos. 13/098,360, entitled “Converged Network Extension,” filed Apr. 29, 2011; 12/725,249, entitled “Redundant Host Connection in a Routed Network,” filed 16 Mar. 2010; 13/087,239, entitled “Virtual Cluster Switching,” filed 14 Apr. 2011; 13/092,724, entitled “Fabric Formation for Virtual Cluster Switching,” filed 22 Apr. 2011; 13/092,580, entitled “Distributed Configuration Management for Virtual Cluster Switching,” filed 22 Apr. 2011; 13/042,259, entitled “Port Profile Management for Virtual Cluster Switching,” filed 7 Mar. 2011; 13/092,460, entitled “Advanced Link Tracking for Virtual Cluster Switching,” filed 22 Apr. 2011; No. 13/092,701, entitled “Virtual Port Grouping for Virtual Cluster Switching,” filed 22 Apr. 2011; 13/092,752, entitled “Name Services for Virtual Cluster Switching,” filed 22 Apr. 2011; 13/092,877, entitled “Traffic Management for Virtual Cluster Switching,” filed 22 Apr. 2011; and 13/092,864, entitled “Method and System for Link Aggregation Across Multiple Switches,” filed 22 Apr. 2011, all hereby incorporated by reference.

In embodiments of the present invention, for the purpose of cross-data-center communication, each data center is represented as a single logical RBridge. This logical RBridge can be assigned a virtual RBridge ID or use the RBridge ID of the CNE device that performs the WAN tunneling.

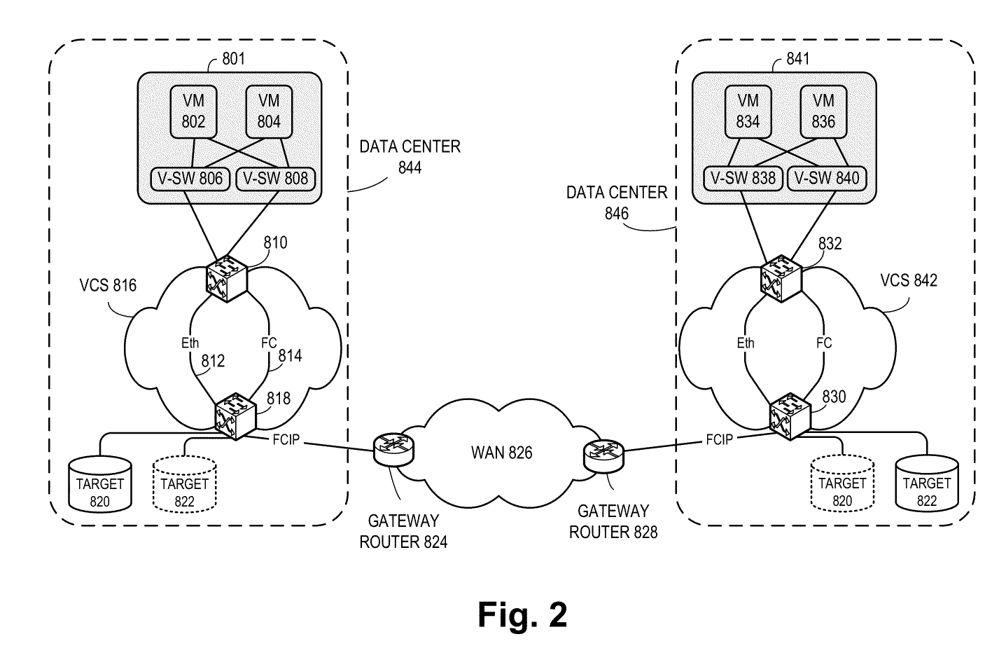

FIG. 2 illustrates an exemplary network architecture which includes CNE devices for facilitating cross-data-center communications, in accordance with one embodiment of the present invention. In this example, two data centers 844 and 846 are coupled to a WAN 826 via gateway routers 824 and 828, respectively. Data center 844 includes a VCS 816, which couples to a number of hosts, such as host 801, via its member switches, such as switch 810. Host 801 includes two VMs 802 and 804, which are coupled to virtual switches 806 and 808 in a dual-homing configuration. In one embodiment, virtual switches 806 and 808 reside on two network interface cards on host 801. Virtual switches 806 and 808 are coupled to VCS member switch 8100. Also included in VCS 816 is a CNE device 818. CNE device 818 is configured to receive both Ethernet (or TRILL) traffic from member switch 810 via an Ethernet (or TRILL) link 812, and FC traffic via FC link 814. Also coupled to CNE device 818 is a target storage device 820, and a cloned target storage device 822 (denoted by dotted lines). CNE device 818 maintains an FCIP tunnel to data center 846 across WAN 826 via gateway routers 824 and 828.

Similar to the data center 844, data center 846 includes a VCS 842, which in turn includes a member switch 832. Member switch 832 is coupled to a host 841, which includes VMs 834 and 836, both of which are coupled to virtual switches 838 and 840. Also included in VCS 842 is a CNE device 830. CNE device 830 is coupled to member switch 832 via an Ethernet (TRILL) link and an FC link. CNE device 830 is also coupled to a target storage device 822 and a clone of target storage device 820.

In previous embodiments, moving VM 802 of the network architecture of FIG. 2 from host 801 to host 841 would not have been possible, because virtual machines are generally only visible within the same layer-2 network domain. Once the layer-2 network domain is terminated by a layer-3 device, such as gateway router 824, all the identifying information for a particular virtual machine (which is carried in layer-2 headers) would be lost. However, in embodiments of the present invention, because the CNE device extends the layer-2 domain from VCS 816 to VCS 842, the movement of VM 802 from data center 844 to data center 846 is now possible.

When forwarding TRILL frames from data center 844 to data center 846, CNE device 818 modifies the egress TRILL frames' header so that the destination RBridge identifier is the RBridge identifier assigned to data center 846. CNE device 818 then uses the FCIP tunnel to deliver these TRILL frames to CNE device 830, which in turn forwards these TRILL frames to their respective layer-2 destinations.

VCS uses the FC control plane to automatically form a fabric and assign RBridge identifiers to each member switch. In one embodiment, the CNE architecture keeps the TRILL and SAN fabrics separate between data centers. From a TRILL point of view, each VCS (which corresponds to a respective data center) is represented as a single virtual RBrdige. In addition, the CNE device can be coupled to a VCS member switch with both a TRILL link and an FC link. However, since the CNE devices keeps the TRILL VCS fabric and SAN (FC) fabrics separate, the FC link between the CNE device and the member switch is generally configured for FC multi-fabric.

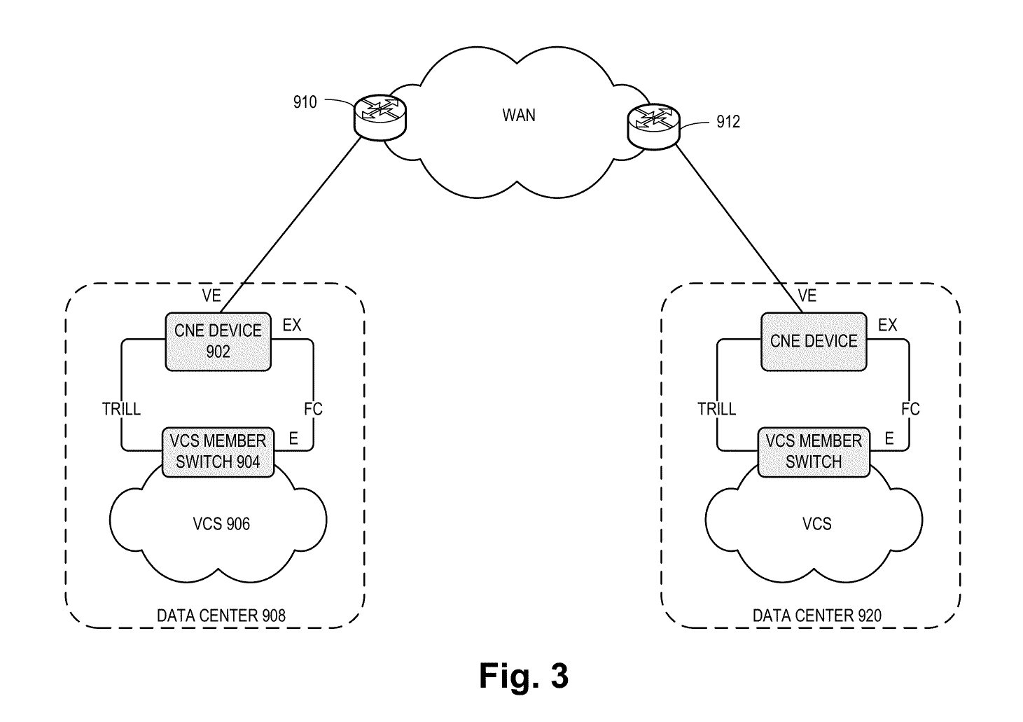

As illustrated in FIG. 3, a data center 908 is coupled to a WAN via a gateway router 910, and a data center 920 is coupled to the WAN via a gateway router 912. Data center 908 includes a VCS 906, which includes a member switch 904. Also included in data center 908 is a CNE device 902. CNE device 902 is coupled to VCS member switch 904 via a TRILL link and an FC link. CNE device 902 can join the VCS via the TRILL link. However, the FC link allows CNE device 902 to maintain a separate FC fabric with VCS member switch 904 to carry FC traffic. In one embodiment, the FC port on CNE device 902 is an FC EX_port. The corresponding port on member switch 904 is an FC E_port. The port on CNE device 902 on the WAN side (coupling to gateway router 910) is an FCIP VE_port. The data center 920 has a similar configuration to that of data center 908.

In one embodiment, each data center's VCS includes a node designated as the ROOT RBridge for multicast purposes. During the initial setup, the CNE devices in the VCSs exchange each VCS's ROOT RBridge identifier. In addition, the CNE devices also exchange each data center's RBridge identifier. Note that this RBridge identifier represents the entire data center. Information related to data-center RBridge identifiers is distributed as a static route to all the nodes in the local VCS.

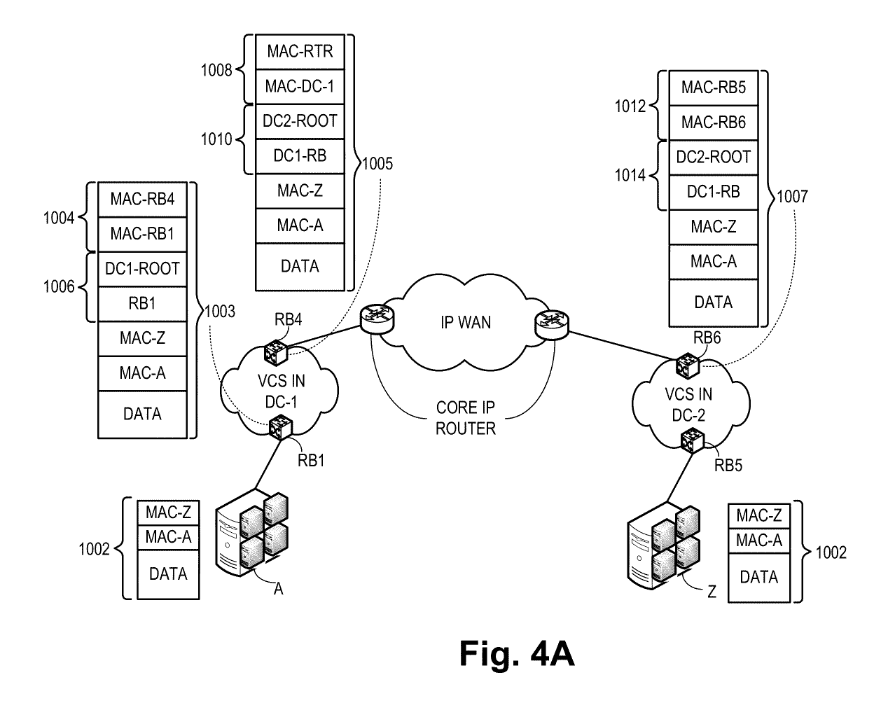

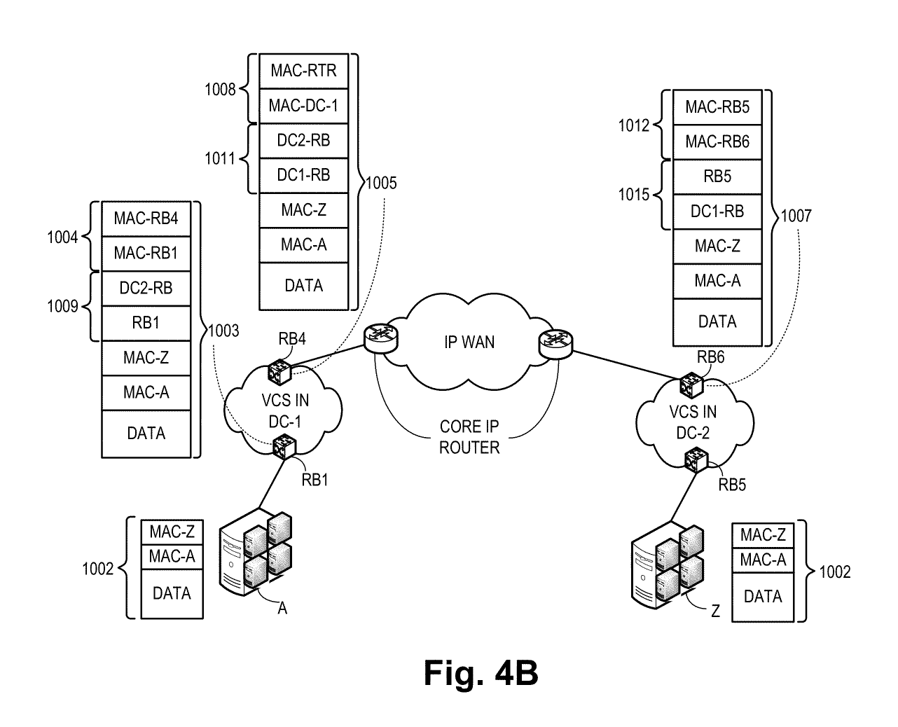

FIG. 4A represents a diagram illustrating how CNE devices handle broadcast, unknown unicast, and multicast (BUM) traffic across data centers, in accordance with one embodiment of the present invention. In this example, two data centers, DC-1 and DC-2, are coupled to an IP WAN via core IP routers. The CNE device in DC-1 has an RBridge identifier of RB4, and the CNE device in DC-2 has an RBridge identifier of RB6. Furthermore, in the VCS in DC-1, a member switch RB1 is coupled to a host A. In the VCS in DC-2, a member switch RB5 is coupled to a host Z.

Assume that host A needs to send multicast traffic to host Z, and that host A already has the knowledge of host Z's MAC address. During operation, host A assembles an Ethernet frame 1002, which has host Z's MAC address (denoted as MAC-Z) as its destination address (DA), and host A's MAC address (denoted as MAC-A) as its source address (SA). Based on frame 1002, member switch RB1 assembles a TRILL frame 1003, whose TRILL header 1006 includes the RBridge identifier of data center DC-1's root RBridge (denoted as “DC1-ROOT”) as the destination RBridge, and RB1 as the source RBridge. (That is, within DC-1, the multicast traffic is distributed on the local multicast tree.) The outer Ethernet header 1004 of frame 1003 has CNE device RB4's MAC address (denoted as MAC-RB4) as the destination address, and member switch RB1's MAC address (denoted as MAC-RB1) as the source address.

When frame 1003 reaches CNE device RB4, it further modifies the frame's TRILL header to produce frame 1005. CNE device RB4 replaces the destination RBridge identifier in the TRILL header 1010 with data center DC-2's root RBridge identifier DC2-ROOT. The source RBridge identifier is changed to data center DC-1's virtual RBridge identifier, DC1-RB (which allows data center DC-2 to learn data center DC-1's RBridge identifier). Outer Ethernet header 1008 has the core router's MAC address (MAC-RTR) as its destination address, and CNE device RB4's MAC address (MAC-DC-1) as its source address.

Frame 1005 is subsequently transported across the IP WAN in an FCIP tunnel and reaches CNE device RB6. Correspondingly, CNE device RB6 updates the header to produce frame 1007. Frame 1007's TRILL header 1014 remains the same as frame 1005. The outer Ethernet header 1012 now has member switch RB5's MAC address, MAC-RB5, as its destination address, and CNE device RB6's MAC address, MAC-RB6, as its source address. Once frame 1007 reaches member switch RB5, the TRILL header is removed, and the inner Ethernet frame is delivered to host Z.

In various embodiments, a CNE device can be configured to allow or disallow unknown unicast, broadcast (e.g., ARP), or multicast (e.g., IGMP snooped) traffic to cross data center boundaries. By having these options, one can limit the amount of BUM traffic across data centers. Note that all TRILL encapsulated BUM traffic between data centers can be sent with the remote data center's root RBridge identifier. This translation is done at the terminating point of the FCIP tunnel.

Additional mechanisms can be implemented to minimize BUM traffic across data centers. For instance, the TRILL ports between the CNE device and any VCS member switch can be configured to not participate in any of the VLAN MGIDs. In addition, the eNS on both VCSs can be configured to synchronize their learned MAC address database to minimize traffic with unknown MAC destination address. In one embodiment, before the learned MAC address databases are synchronized in different VCSs, frames with unknown MAC destination addresses are flooded within the local data center only.

To further minimize BUM traffic, broadcast traffic such as ARP traffic can be reduced by snooping ARP responses to build ARP databases on VCS member switches. The learned ARP databases are then exchanged and synchronized across different data centers using eNS. Proxy-based ARP is used to respond to all known ARP requests in a VCS. Furthermore, multicast traffic across data centers can be reduced by distributing the multicast group membership across data canters through sharing the IGMP snooping information via eNS.

The process of forwarding unicast traffic between data centers is as follows. During the FCIP tunnel formation, the logical RBridge identifiers representing data centers are exchanged. When a TRILL frame arrives at the entry node of the FCIP tunnel, wherein the TRILL destination RBridge is set as the RBridge identifier of the remote data center, the source RBridge in the TRILL header is translated to the logical RBridge identifier assigned to the local data center. When the frame exits the FCIP tunnel, the destination RBridge field in the TRILL header is set as the local (i.e., the destination) data center's virtual RBridge identifier. The MAC DA and VLAN ID in the inner Ethernet header are then used to look up the corresponding destination RBridge (i.e., the RBridge identifier of the member switch to which the destination host is attached), and the destination RBridge field in the TRILL header is updated accordingly.

In the destination data center, based on an ingress frame, all the VCS member switches learn the mapping between the MAC SA (in the inner Ethernet header of the frame) and the TRILL source RBridge (which is the virtual RBridge identifier assigned to the source data center). This allows future egress frames destined to that MAC address to be sent to the right remote data center. Because the RBridge identifier assigned to a given data center does not correspond to a physical RBridge, in one embodiment, a static route is used to map a remote data-center RBridge identifier to the local CNE device.

FIG. 4B represents a diagram illustrating how CNE devices handle unicast traffic across data centers, in accordance with one embodiment of the present invention. Assuming that host A needs to send unicast traffic to host Z, and that host A already has the knowledge of host Z's MAC address, during operation, host A assembles an Ethernet frame 1002, which has host Z's MAC address (MAC-Z) as its DA, and host A's MAC address (MAC-A) as its SA. Based on frame 1002, member switch RB1 assembles a TRILL frame 1003, whose TRILL header 1009 includes the RBridge identifier of data center DC-2's virtual Rbridge (denoted as “DC2-RB”) as the destination RBridge, and RB1 as the source RBridge. The outer Ethernet header 1004 of frame 1003 has CNE device RB4's MAC address (MAC-RB4) as the DA, and member switch RB1's MAC address (MAC-RB1) as the SA.

When frame 1003 reaches CNE device RB4, it further modifies the frame's TRILL header to produce frame 1005. CNE device RB4 replaces the source RBridge identifier in the TRILL header 1011 with data center DC-1's virtual RBridge identifier DC1-RB (which allows data center DC-2 to learn data center DC-1's RBridge identifier). Outer Ethernet header 1008 has the core router's MAC address (MAC-RTR) as its DA, and CNE device RB4's MAC address (MAC-DC-1) as its SA.

Frame 1005 is subsequently transported across the IP WAN in an FCIP tunnel and reaches CNE device RB6. Correspondingly, CNE device RB6 updates the header to produce frame 1007. Frame 1007's TRILL header 1015 has an updated destination RBridge identifier, which is RB5, the VCS member switch in DC-2 that couples to host Z. The outer Ethernet header 1012 now has member switch RB5's MAC address, MAC-RB5, as its DA, and CNE device RB6's MAC address, MAC-RB6, as its SA. Once frame 1007 reaches member switch RB5, the TRILL header is removed, and the inner Ethernet frame is delivered to host Z.

Flooding across data centers of frames with unknown MAC DAs is one way for the data centers to learn the MAC address in another data center. All unknown SAs are learned as MACs behind an RBridge and it is no exception for the CNE device. In one embodiment, eNS can be used to distribute learned MAC address database, which reduces the amount of flooding across data centers.

In order to optimize flushes, even though MAC addresses are learned behind RBridges, the actual VCS edge port associated with a MAC address can be present in the eNS MAC updates. However, the edge port IDs might no longer be unique across data-centers. To resolve this problem, all eNS updates across data centers will qualify the MAC entry with the data-center's RBridge identifier. This configuration allows propagation of port flushes across data centers.

In the embodiments described herein, VCSs in different data-centers do not join each other and thus the distributed configurations are kept separate. However, in order to allow virtual machines to move across data-centers, there maybe some configuration data that needs to be synchronized across data-centers. In one embodiment, a special module (in either software or hardware) is created for CNE purposes. This module is configured to retrieve the configuration information needed to facilitate moving of virtual machines across data centers and it is synchronized between two or more VCSs.

In one embodiment, the learned MAC address databases are distributed across data centers. Additionally, edge port state change notifications (SCNs) may be distributed across data centers. When a physical RBridge is going down, the SCN is converted to multiple port SCNs on the inter-data-center FCIP link.

In order to protect the inter-data-center connectivity, a VCS can form a vLAG between two or more CNE devices. In this model, the vLAG RBridge identifier is used as the data-center RBridge identifier. The FCIP control plane is configured to be aware of this arrangement and exchange the vLAG RBridge identifiers in such cases.

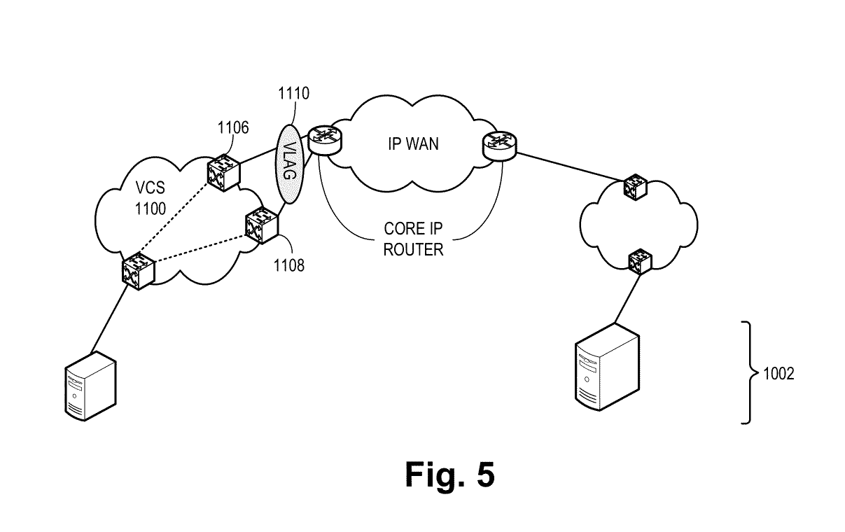

FIG. 5 illustrates an example where two CNE devices are used to construct a vLAG, in accordance with an embodiment of the present invention. In this example, a VCS 1100 includes two CNE devices 1106 and 1108. Both CNE devices 1106 and 1106 form a vLAG 1100 which is coupled to a core IP router. vLAG 1110 is assigned a virtual RBridge identifier, which is also used as the data-center RBridge identifier for VCS 1100. Furthermore, vLAG 1110 can facilitate both ingress and egress load balancing (e.g., based on equal-cost multi-pathing (ECMP)) for any member switch within VCS 1100.

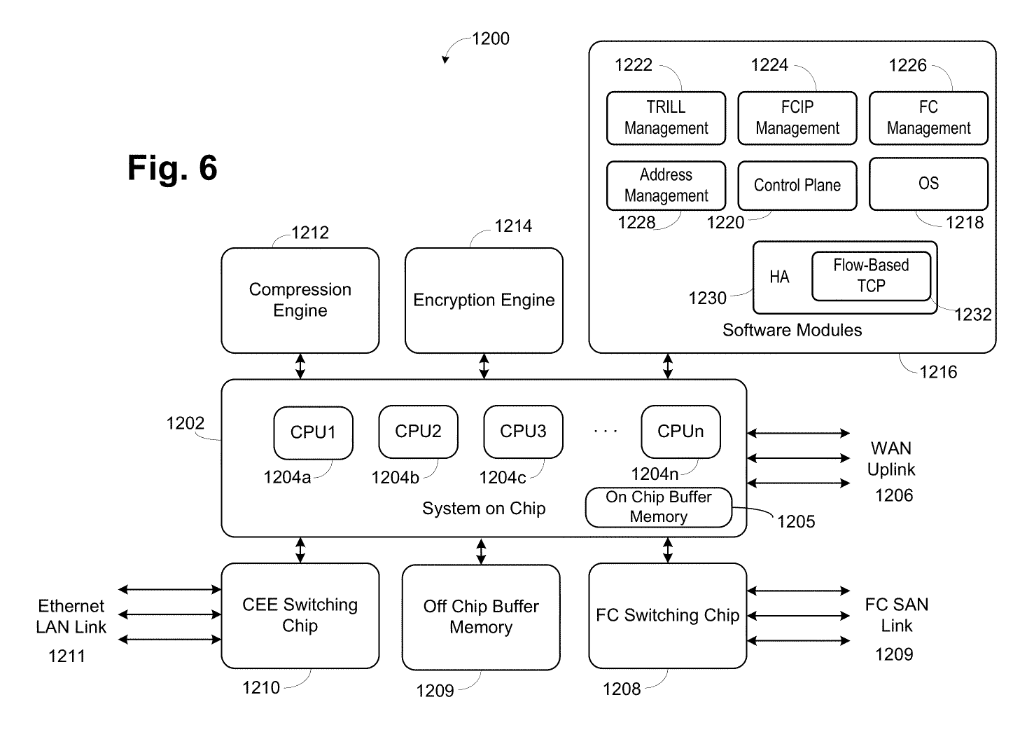

FIG. 6 illustrates a CNE/LDCM device 1200, in which the LDCM features are preferably added to a CNE device to create a single device. A system on chip (SOC) 1202 provides the primary processing capabilities, having a plurality of CPUs 1204 and an amount of on chip buffer memory 1205 to be used as needed. A number of Ethernet connections 1206 are preferably included on the SOC 1202 to act as the WAN link, though a separate Ethernet device could be used if desired. An FC switching chip 1208 is connected to the SOC 1202 to provide connections to FC SANs. A CEE switching chip 1210 is connected to the SOC 1202 to allow attachment to the VCS or to an Ethernet LAN. Off chip buffer memory 1209 which is generally much larger than the on chip buffer memory 1205 is provided for additional buffer space as needed. A compression engine 1212 is provided with the SOC 1202 to provide compression and deduplication capabilities to reduce traffic over the WAN links. An encryption engine 1214 is provided for security purposes, as preferably the FCIP tunnel is encrypted for security.

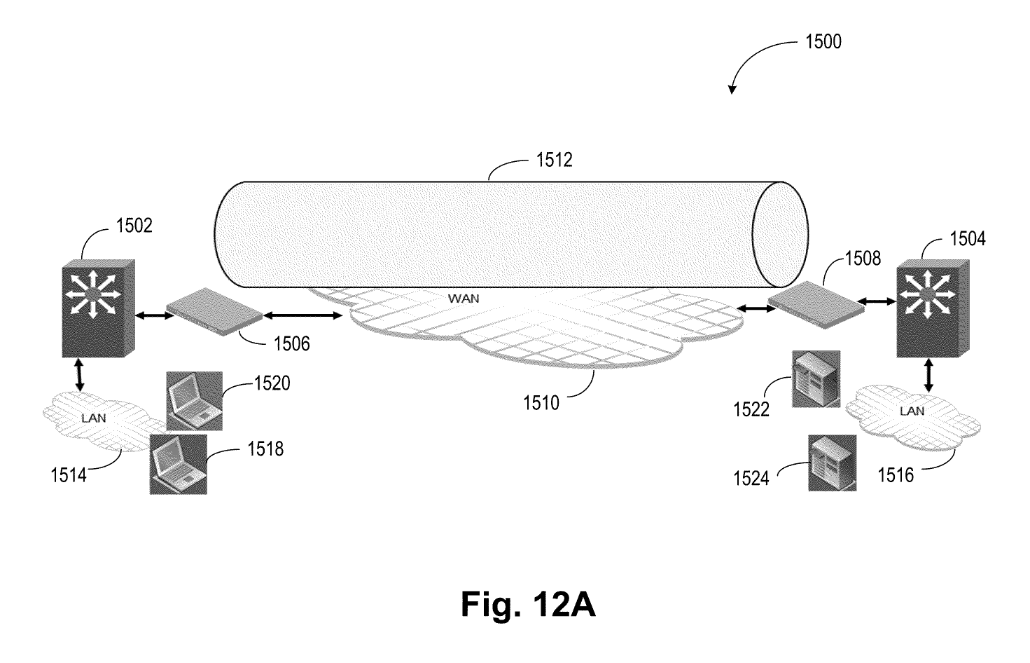

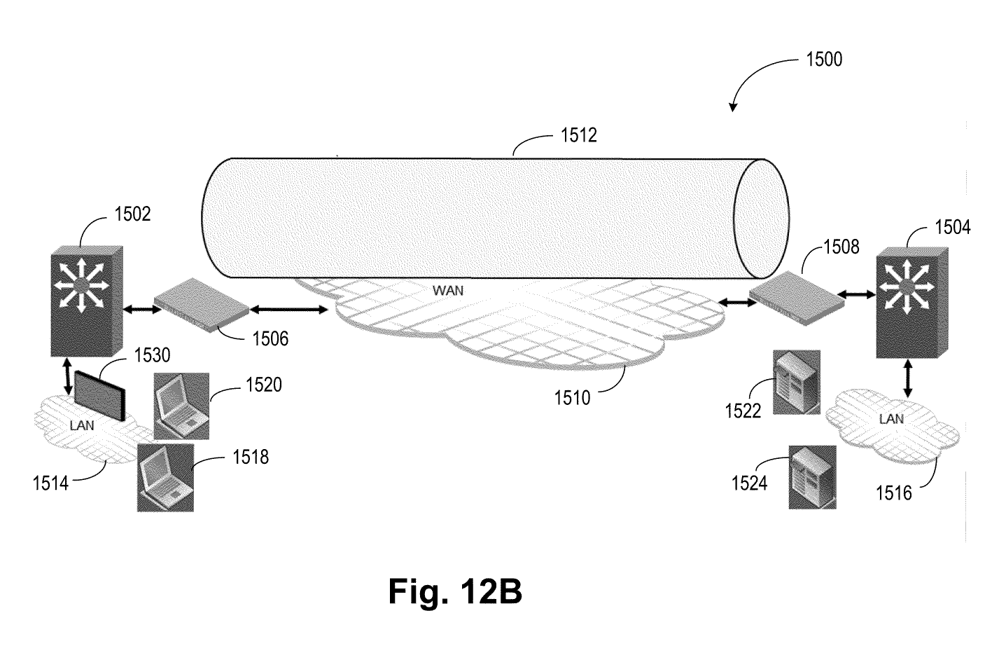

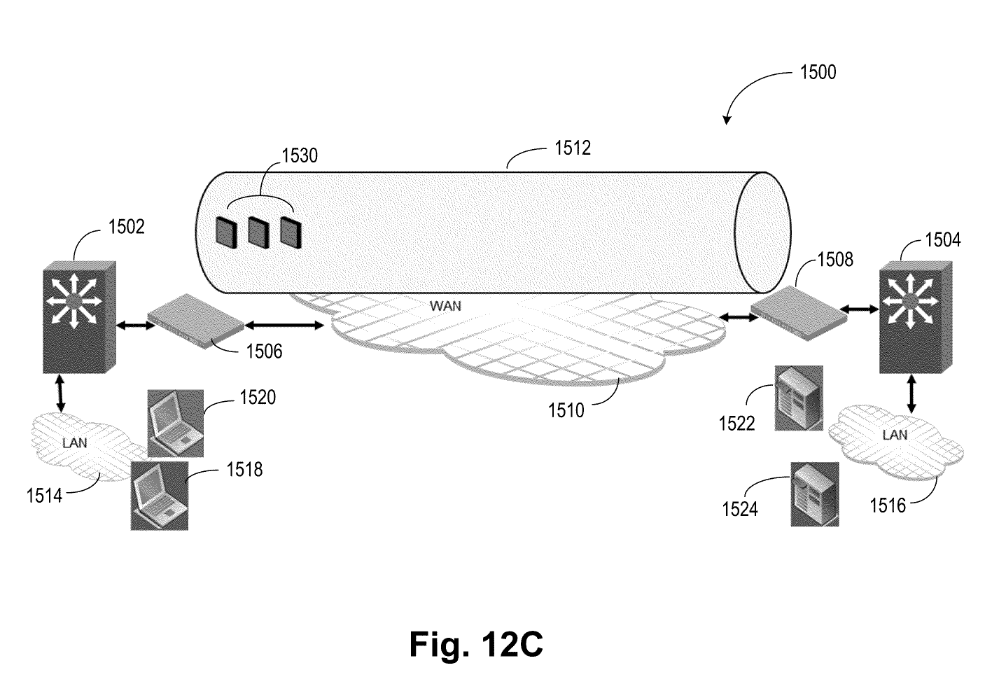

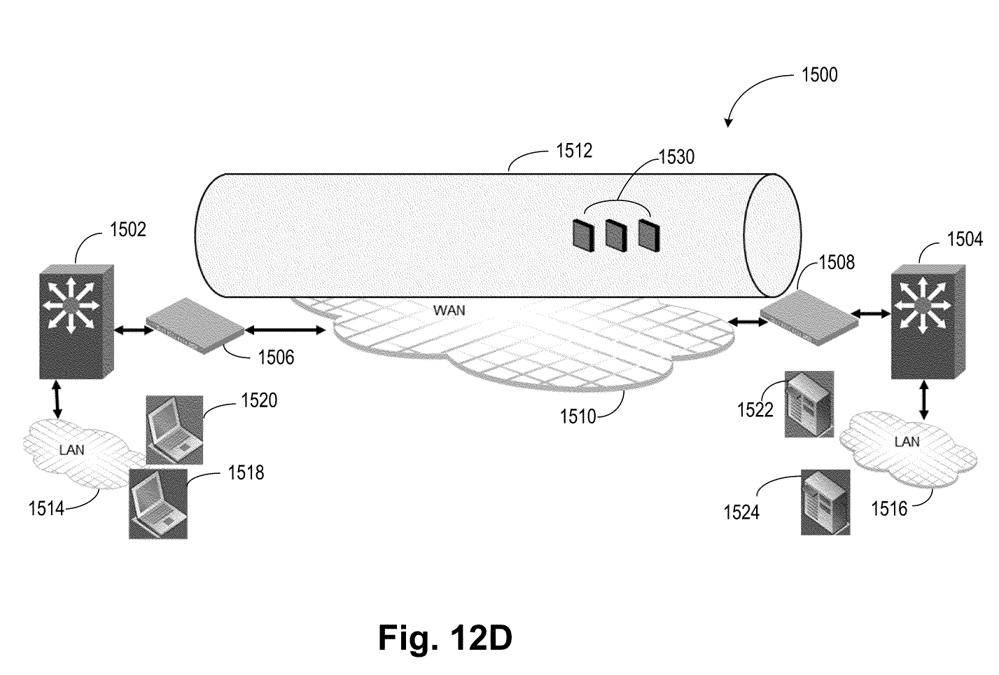

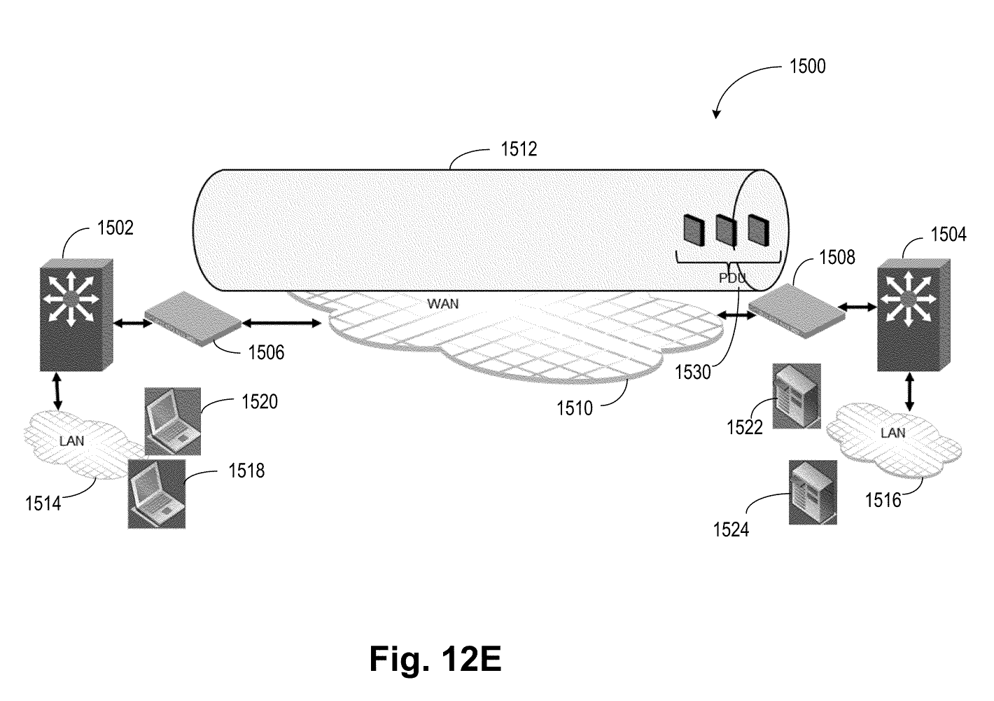

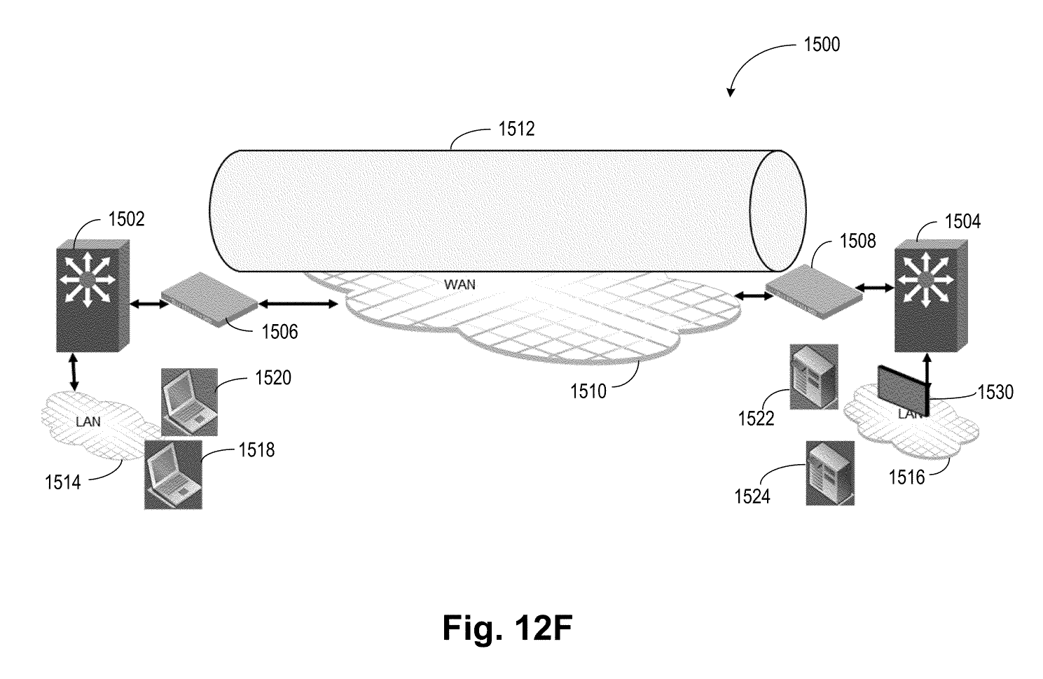

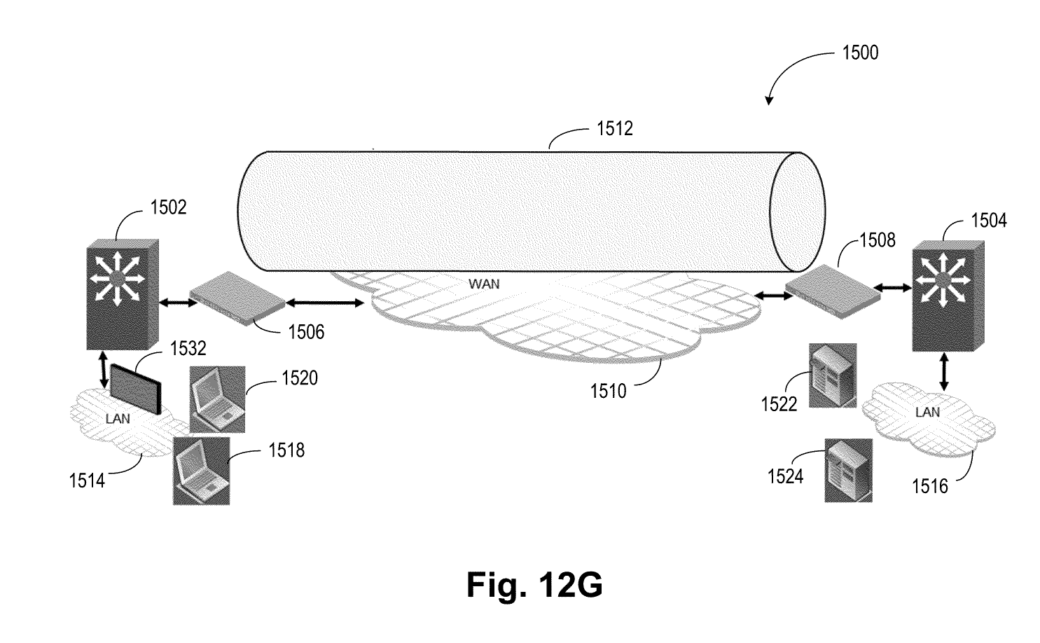

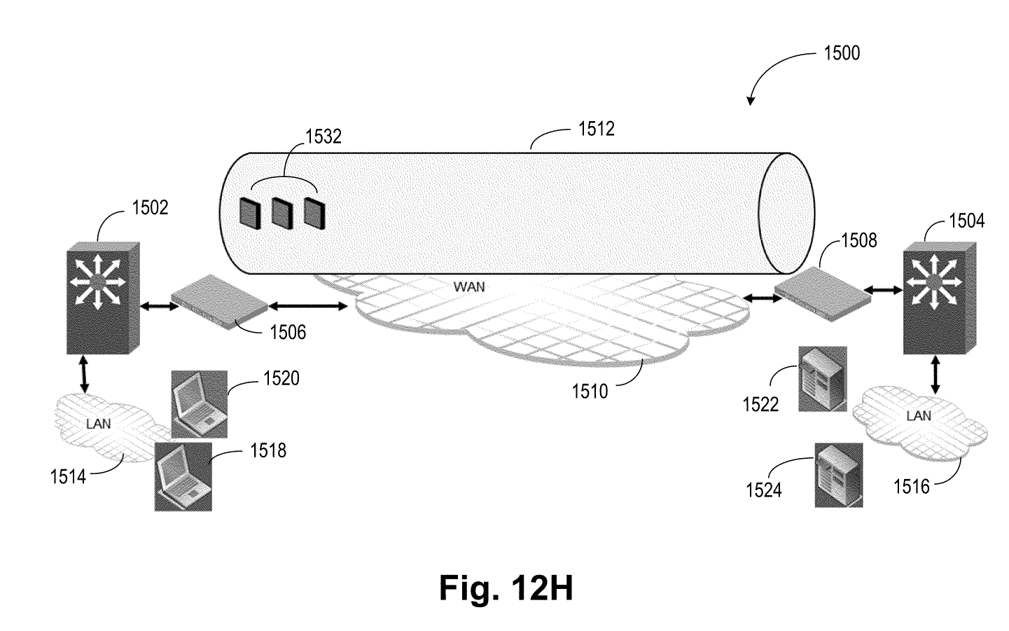

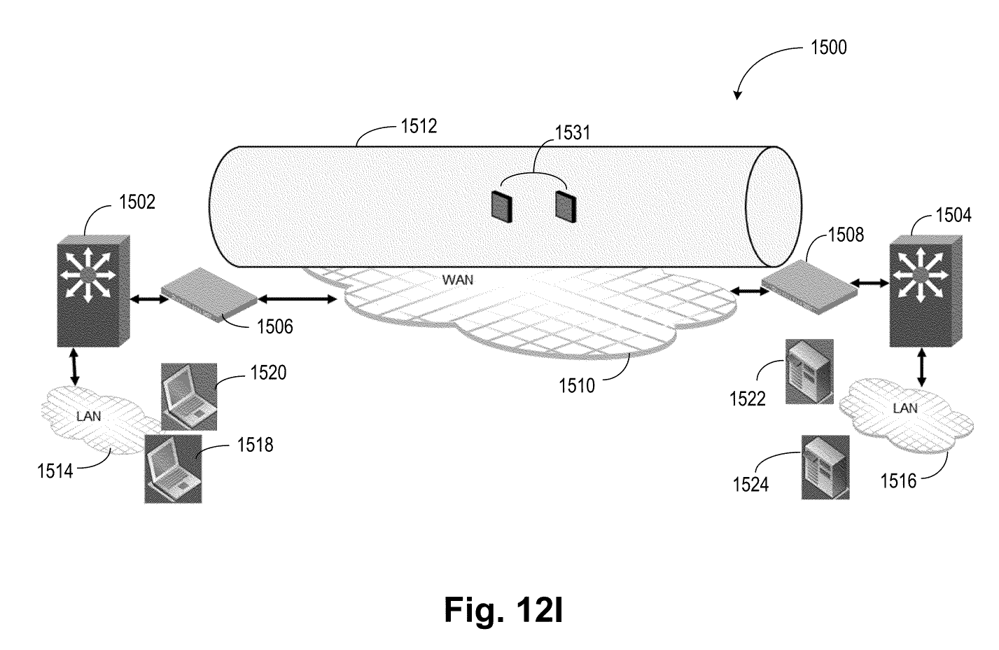

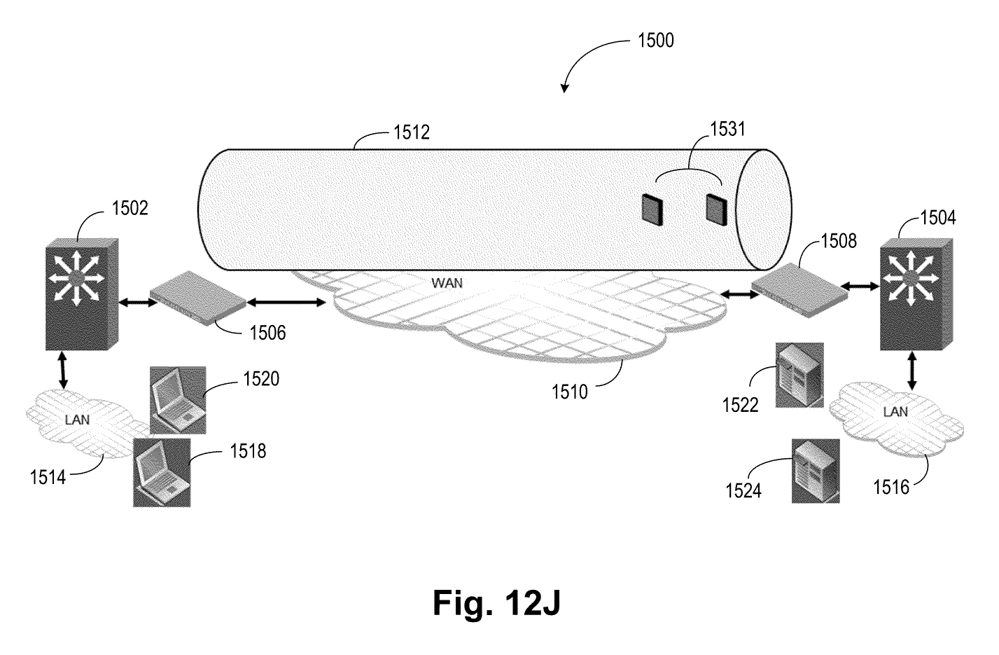

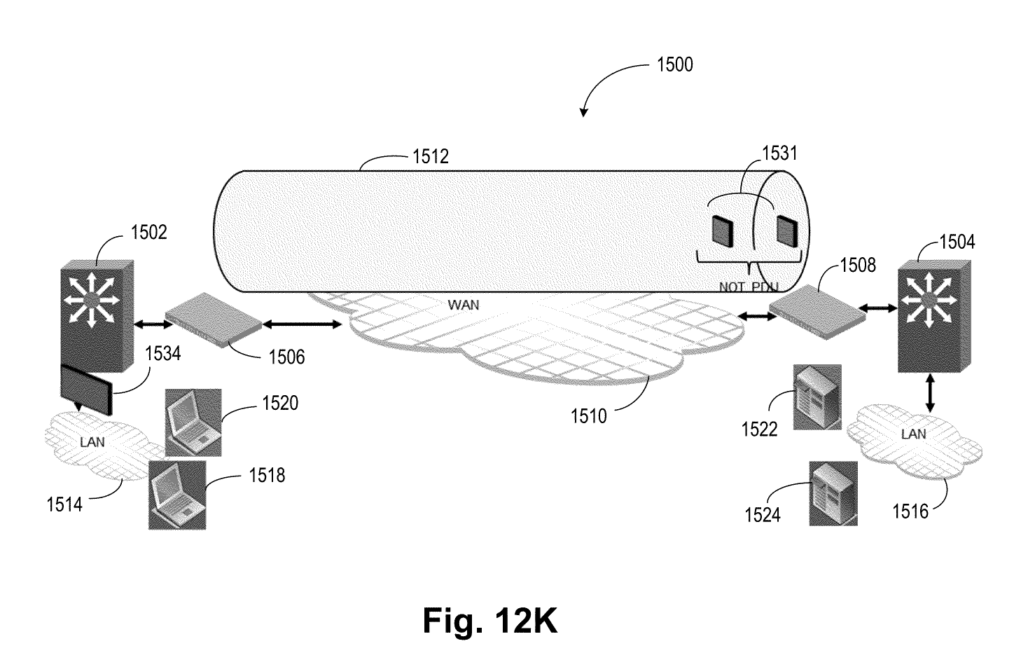

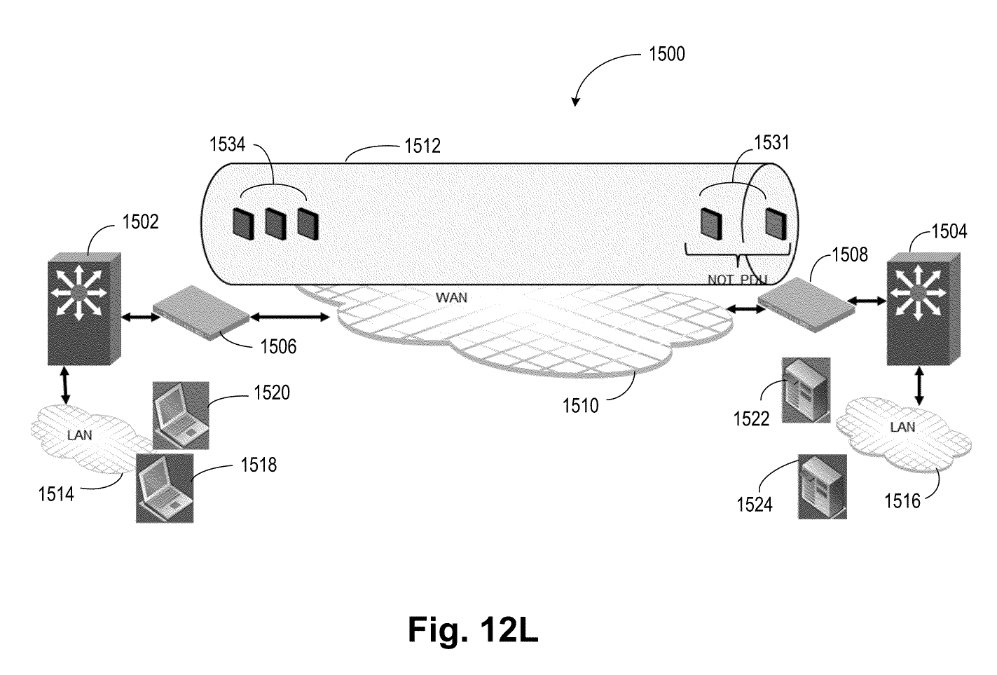

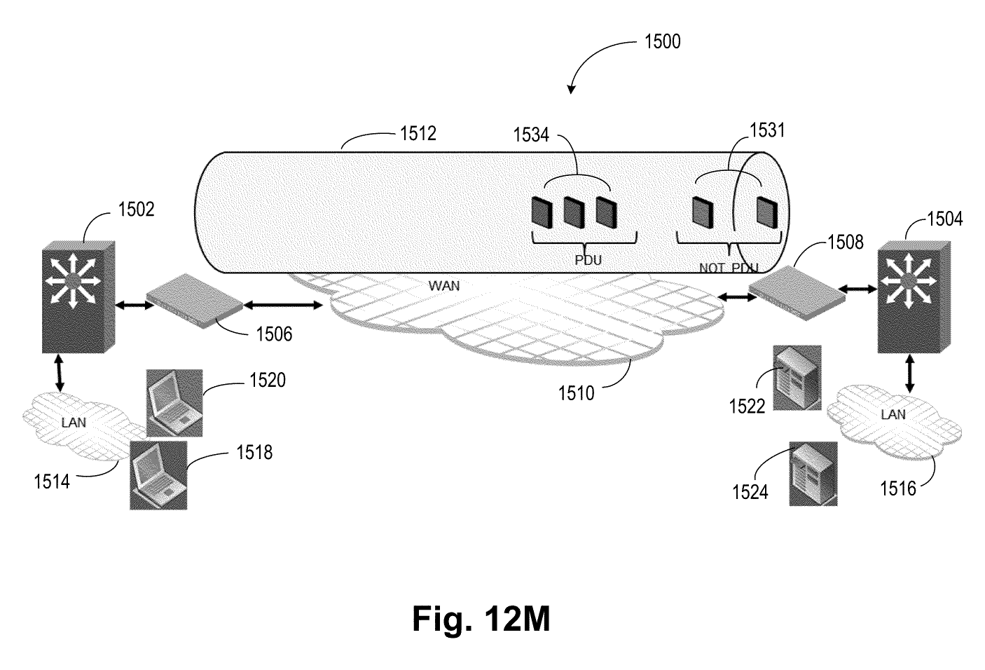

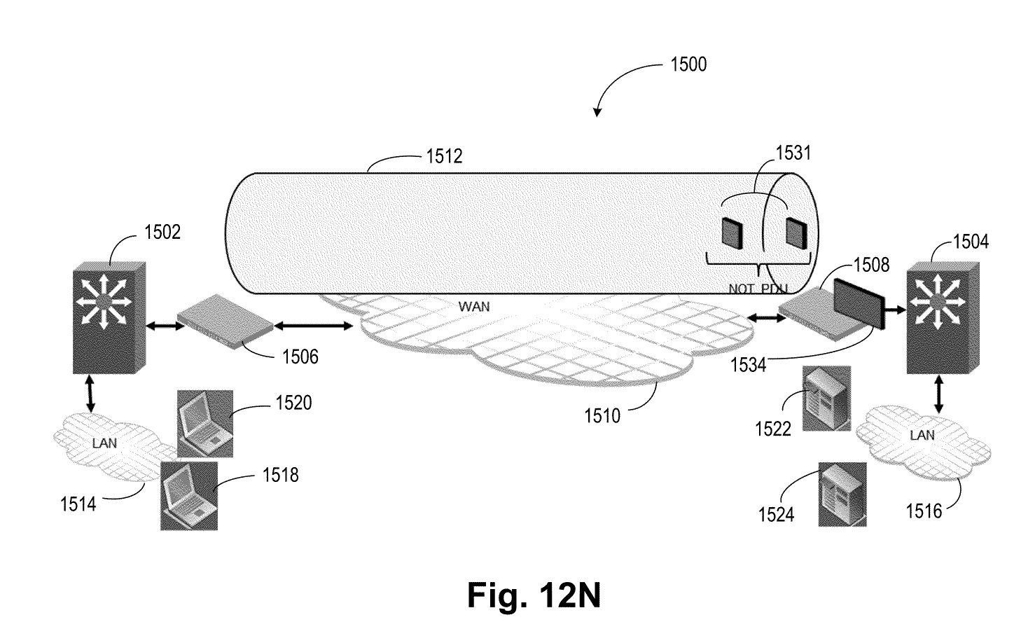

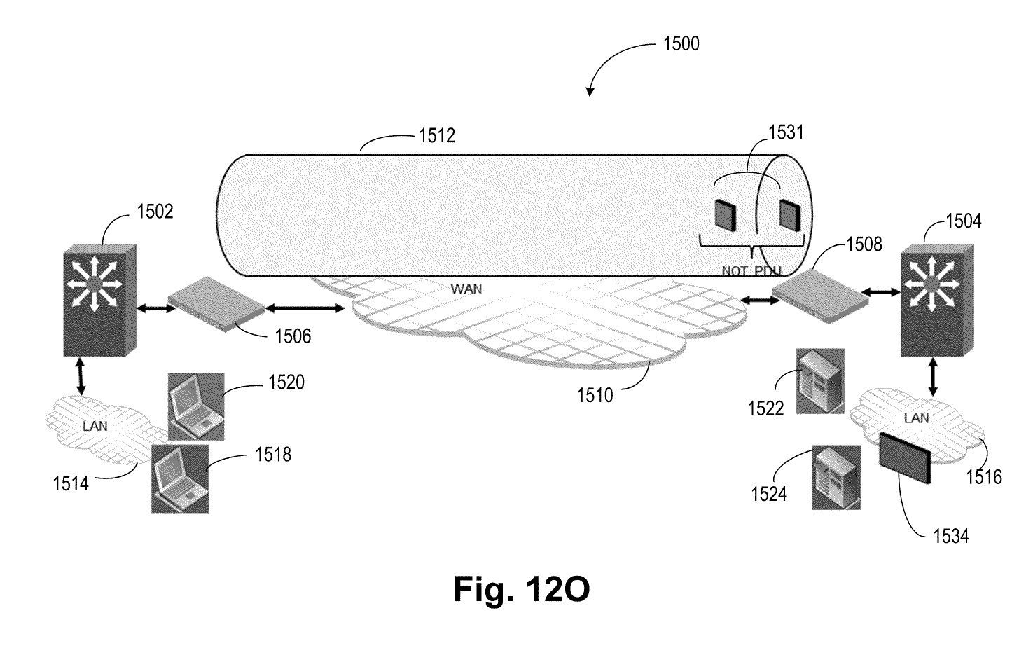

Various software modules 1216 are present in the CNE/LDCM device 1200. These include an underlying operating system 1218, a control plane module 1220 to manage interaction with the VCS, a TRILL management module 1222 for TRILL functions above the control plane, an FCIP management module 1224 to manage the FCIP tunnels over the WAN, an FC management module 1226 to interact with the FC SAN and an address management module 1228. An additional module is a high availability (HA) module 1230, which in turn includes a flow-based TCP submodule 1232. The software in the connection flow-based TCP submodule 1232 is executed in the CPUs 1204 to perform the flow-based TCP operations described below relating to FIGS. 12A-16.

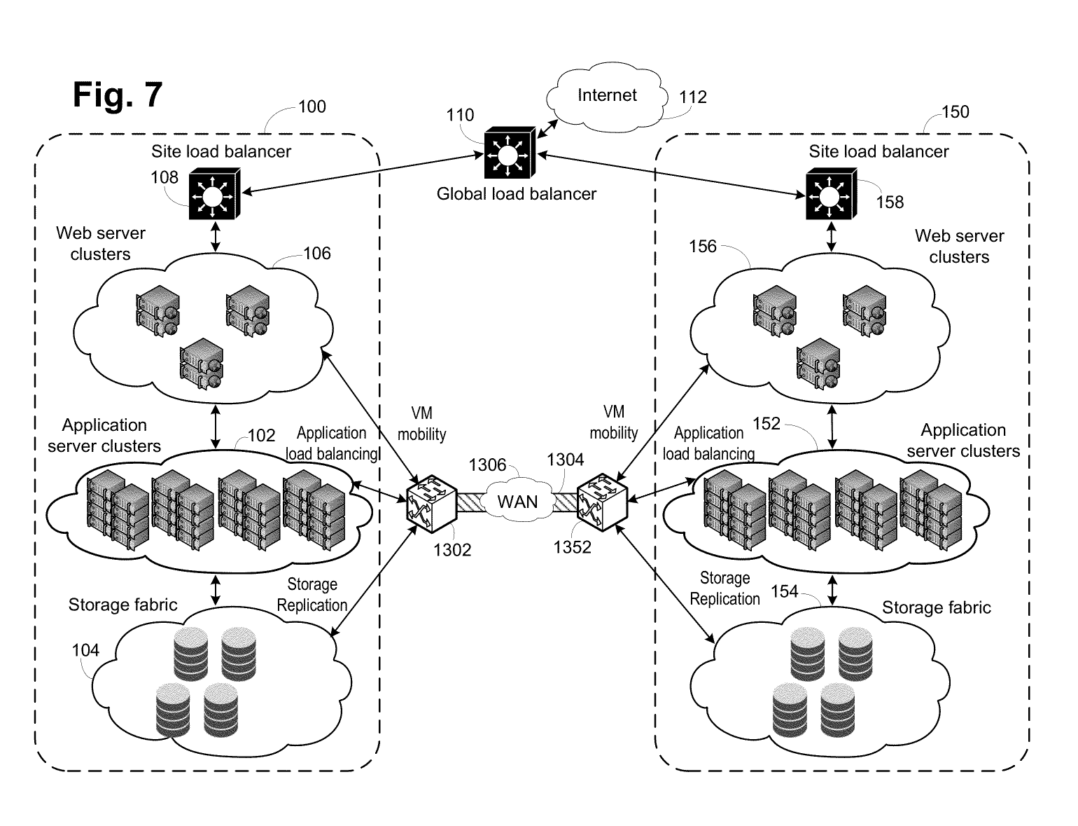

FIG. 7 illustrates the addition of CNE/LDCM devices 1302 and 1352. The CNE/LDCM devices 1302 and 1352 create a cloud virtual interconnect (CVI) 1304 between themselves, effectively an FCIP tunnel through the WAN 1306. The CVI 1304 is used for VM mobility, application load balancing and storage replication between the data centers 100 and 150.

The cloud virtual interconnect 1304 preferably includes the following components: an FCIP trunk, as more fully described in U.S. patent application Ser. No. 12/880,495, entitled “FCIP Communications with Load Sharing and Failover”, filed Sep. 13, 2010, which is hereby incorporated by reference, and aggregates multiple TCP connections to support wide WAN bandwidth ranges from 100 Mbps up to 20 Gbps. It also supports multi-homing and enables transparent failover between redundant network paths.

Adaptive rate limiting (ARL) is performed on the TCP connections to change the rate at which data is transmitted through the TCP connections. ARL uses the information from the TCP connections to determine and adjust the rate limit for the TCP connections dynamically. This will allow the TCP connections to utilize the maximum available bandwidth. It also provides a flexible number of priorities for defining policies and the users are provisioned to define the priorities needed.

High bandwidth TCP (HBTCP) is designed to be used for high throughput applications, such as virtual machine and storage migration, over long fat networks. It overcomes the challenge of the negative effect of traditional TCP/IP in WAN. In order to optimize the performance, the following changes can be made.

1) Scaled Windows: In HBTCP, scaled windows are used to support WAN latencies of up to 350 ms or more. Maximum consumable memory will be allocated per session to maintain the line rate.

2) Optimized reorder resistance: HBTCP has more resistance to duplicate acknowledgements and requires more duplicate ACK's to trigger the fast retransmit.

3) Optimized fast recovery: In HBTCP, instead of reducing the cwnd by half, it is reduced by substantially less than 50% in order to make provision for the cases where extensive network reordering is done.

4) Quick Start: The slow start phase is modified to quick start where the initial throughput is set to a substantial value and throughput is only minimally reduced when compared to the throughput before the congestion event.

5) Congestion Avoidance: By carefully matching the amount of data sent to the network speed, congestion is avoided instead of pumping more traffic and causing a congestion event so that congestion avoidance can be disabled.

6) Optimized slow recovery: The retransmission timer in HBTCP (15 ms) expires much quicker than in traditional TCP and is used when fast retransmit cannot provide recovery. This triggers the slow start phase earlier when a congestion event occurs.

7) Lost packet continuous retry: Instead of waiting on an ACK for a SACK retransmitted packet, continuously retransmit the packet to improve the slow recovery, as described in more detail in U.S. patent application Ser. No. 12/972,713, entitled “Repeated Lost Packet Retransmission in a TCP/IP Network”, filed Dec. 20, 2010, which is hereby incorporated by reference.

The vMotion migration data used in VM mobility for VMware systems enters the CNE/LDCM device 1302 through the LAN Ethernet links of the CEE switching chip 1210 and the compressed, encrypted data is sent over the WAN infrastructure using the WAN uplink using the Ethernet ports 1206 of the SOC 1202. Similarly for storage migration, the data from the SAN FC link provided by the FC switching chip 1208 is migrated using the WAN uplink to migrate storage. The control plane module 1220 takes care of establishing, maintaining and terminating TCP sessions with the application servers and the destination LDCM servers.

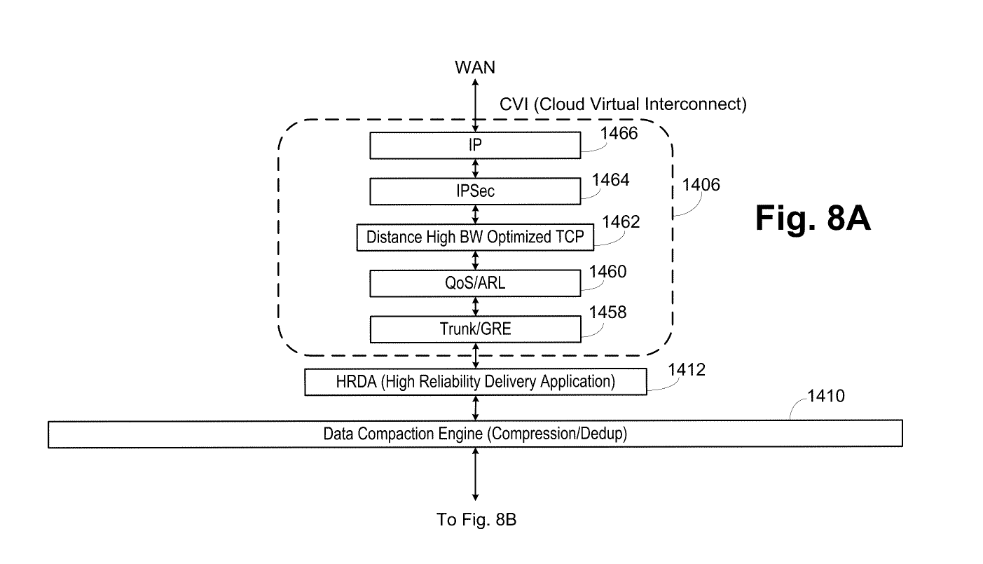

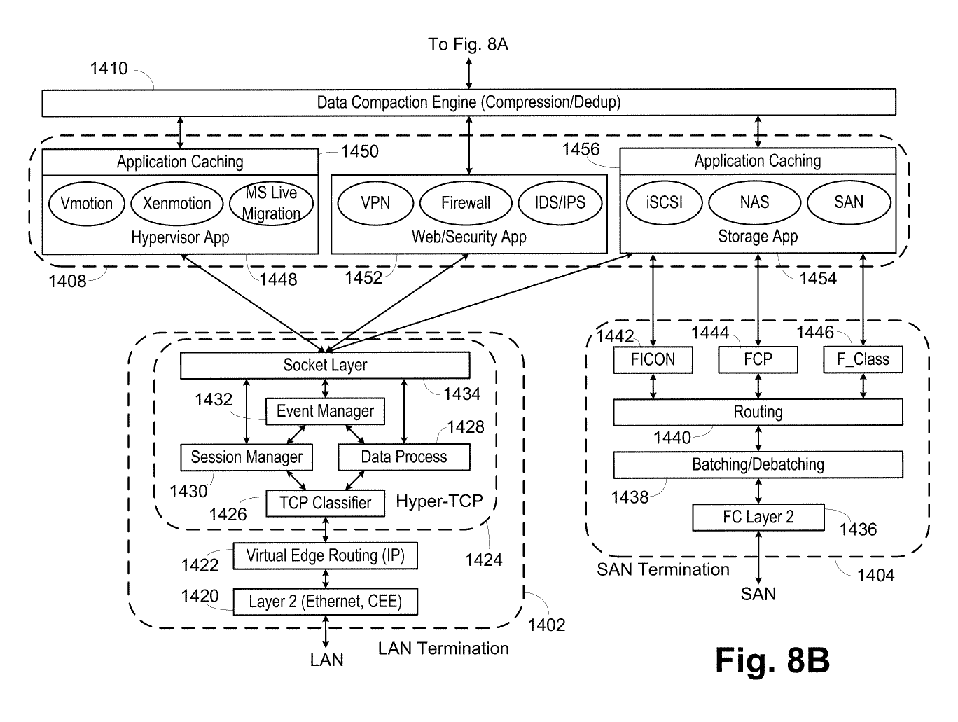

FIGS. 8A and 8B illustrate the functional blocks and modules of a preferred embodiment of the CNE/LDCM device. LAN termination 1402 and SAN termination 1404 are interconnected to the CVI 1406 through an application module 1408, the data compaction engine 1410 and a high reliability delivery application (HRDA) layer 1412.

LAN termination 1402 has a layer 2, Ethernet or CEE, module 1420 connected to the LAN ports. An IP virtual edge routing module 1422 connects the layer 2 module 1420 to a Hyper-TCP module 1424. The Hyper-TCP module 1424 operation is described in more detail below and includes a TCP classifier 1426 connected to the virtual edge routing module 1422. The TCP classifier 1426 is connected to a data process module 1428 and a session manager 1430. An event manager 1432 is connected to the data process module 1428 and the session manager 1430. The event manager 1432, the data process module 1428 and the session manager 1430 are all connected to a socket layer 1434, which acts as the interface for the Hyper-TCP module 1424 and the LAN termination 1402 to the application module 1408.

SAN termination 1404 has an FC layer 2 module 1436 connected to the SAN ports. A batching/debatching module 1438 connects the FC layer 2 module 1436 to a routing module 1440. Separate modules are provided for FICON traffic 1442, FCP traffic 1444 and F_Class traffic 1446, with each module connected to the routing module 1440 and acting as interfaces between the SAN termination 1404 and the application module 1408.

The application module 1408 has three primary applications, hypervisor 1448, web/security 1452 and storage 1454. The hypervisor application 1448 cooperates with the various hypervisor motion functions, such vMotion, Xenmotion and MS Live Migration. A caching subsystem 1450 is provided with the hypervisor application 1448 for caching of data during the motion operations. The web/security application 1452 cooperates with VPNs, firewalls and intrusion systems. The storage application 1454 handles iSCSI, NAS and SAN traffic and has an accompanying cache 1456.

The data compaction engine 1410 uses the compression engine 1212 to handle compression/decompression and deduplicaton operations to allow improved efficiency of the WAN links.

The main function of the HRDA layer 1412 is to ensure the communication reliability at the network level and also at the transport level. As shown, the data centers are consolidated by extending the L2 TRILL network over IP through the WAN infrastructure. The redundant links are provisioned to act as back up paths. The HRDA layer 1412 performs a seamless switchover to the backup path in case the primary path fails. HBTCP sessions running over the primary path are prevented from experiencing any congestion event by retransmitting any unacknowledged segments over the backup path. The acknowledgements for the unacknowledged segments and the unacknowledged segments themselves are assumed to be lost. The HRDA layer 1412 also ensures reliability for TCP sessions within a single path. In case a HBTCP session fails, any migration application using the HBTCP session will also fail. In order to prevent the applications from failing, the HRDA layer 1412 transparently switches to a backup HBTCP session.

The CVI 1406 includes an IP module 1466 connected to the WAN links. An IPSEC module 1464 is provided for link security. A HBTCP module 1462 is provided to allow the HBTCP operations as described above and to perform the out of order delivery of PDUs to the upper layer and advertised receive window changes as described below. A QoS/ARL module 1460 handles the QoS and the ARL function described above. A trunk module 1458 handles trunking operations.

Hyper-TCP is a component in accelerating the migration of live services and applications over long distance networks. Simply, a TCP session between the application client and server is locally terminated and by leveraging the high bandwidth transmission techniques between the data centers, application migration is accelerated.

Hyper-TCP primarily supports two modes of operation:

1) Data Termination Mode (DTM): In data termination mode, the end device TCP sessions are not altered but the data is locally acknowledged and data sequence integrity is maintained.

2) Complete Termination Mode (CTM): In the complete termination mode, end device TCP sessions are completely terminated by the LDCM. Data sequence is not maintained between end devices but data integrity is guaranteed.

There are primarily three phases in Hyper-TCP. They are Session Establishment, Data Transfer and Session Termination. These three phases are explained below.

1) Session Establishment: During this phase, the connection establishment packets are snooped and the TCP session data, like connection end points, Window size, MTU and sequence numbers, are cached. The Layer 2 information like the MAC addresses is also cached. The TCP session state on the Hyper-TCP server is the same as that of the application server and the TCP session state of the Hyper-TCP client is the same as application client. With the cached TCP state information, the Hyper-TCP devices can locally terminate the TCP connection between the application client and server and locally acknowledge the receipt of data packets. Hence, the RTT's calculated by the application will be masked from including the WAN latency, which results in better performance.

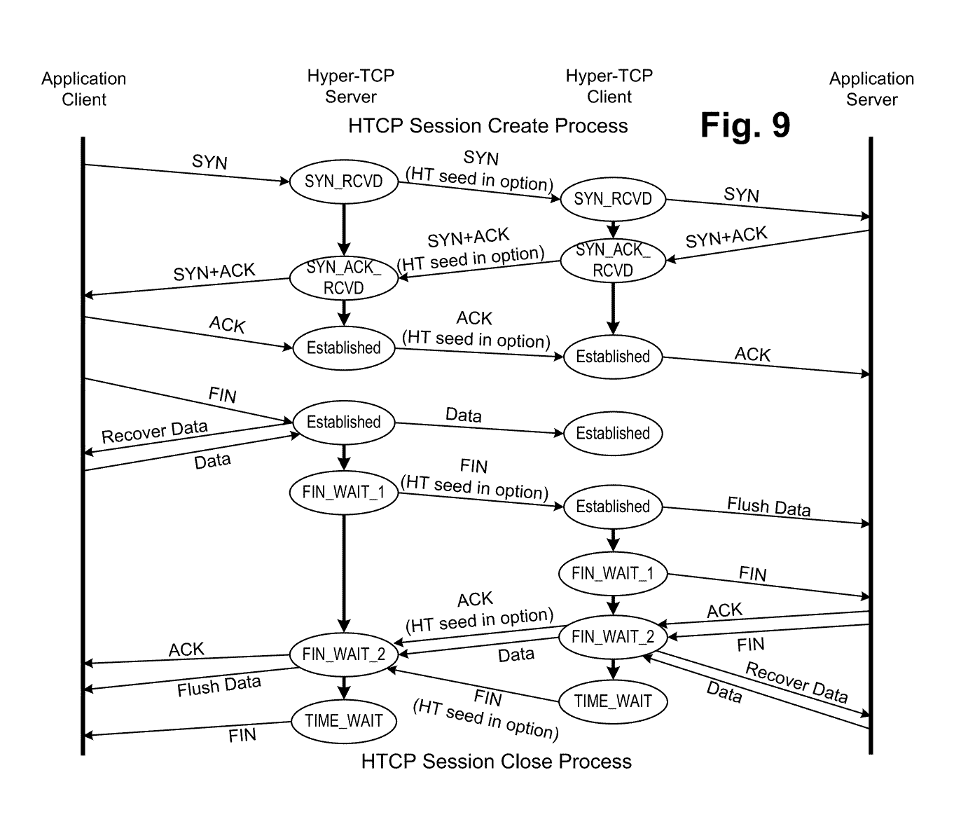

The session create process is illustrated in FIG. 9. The application client transmits a SYN, which is snooped by the Hyper-TCP server. The Hyper-TCP server forwards the SYN to the Hyper-TCP client, potentially with a seed value in the TCP header options field. The seed value can indicate whether this is a Hyper-TCP session, a termination mode, the Hyper-TCP version and the like. The seed value is used by the various modules, such as the data compaction engine 1410 and the CVI 1406, to determine the need for and level of acceleration of the session. The Hyper-TCP client snoops and forwards the SYN to the application server. The application server responds with a SYN+ACK, which the Hyper-TCP client snoops and forwards to the Hyper-TCP server. The Hyper-TCP server snoops the SYN+ACK and forwards it to the application client. The application client responds with an ACK, which the Hyper-TCP server forwards to the Hyper-TCP client, which in turn provides it to the application server. This results in a created TCP session.

2) Data Transfer Process: Once the session has been established, the data transfer is always locally handled between a Hyper-TCP device and the end device. A Hyper-TCP server acting as a proxy destination server for the application client locally acknowledges the data packets and the TCP session state is updated. The data is handed over to the HBTCP session between the Hyper-TCP client and server. HBTCP session compresses and forwards the data to the Hyper-TCP client. This reduces the RTT's seen by the application client and the source as it masks the latencies incurred on the network.

The data received at the Hyper-TCP client is treated as if the data has been generated by the Hyper-TCP client and the data is handed to the Hyper-TCP process running between the Hyper-TCP client and the application server. Upon congestion in the network, the amount of data fetched from the Hyper-TCP sockets is controlled.

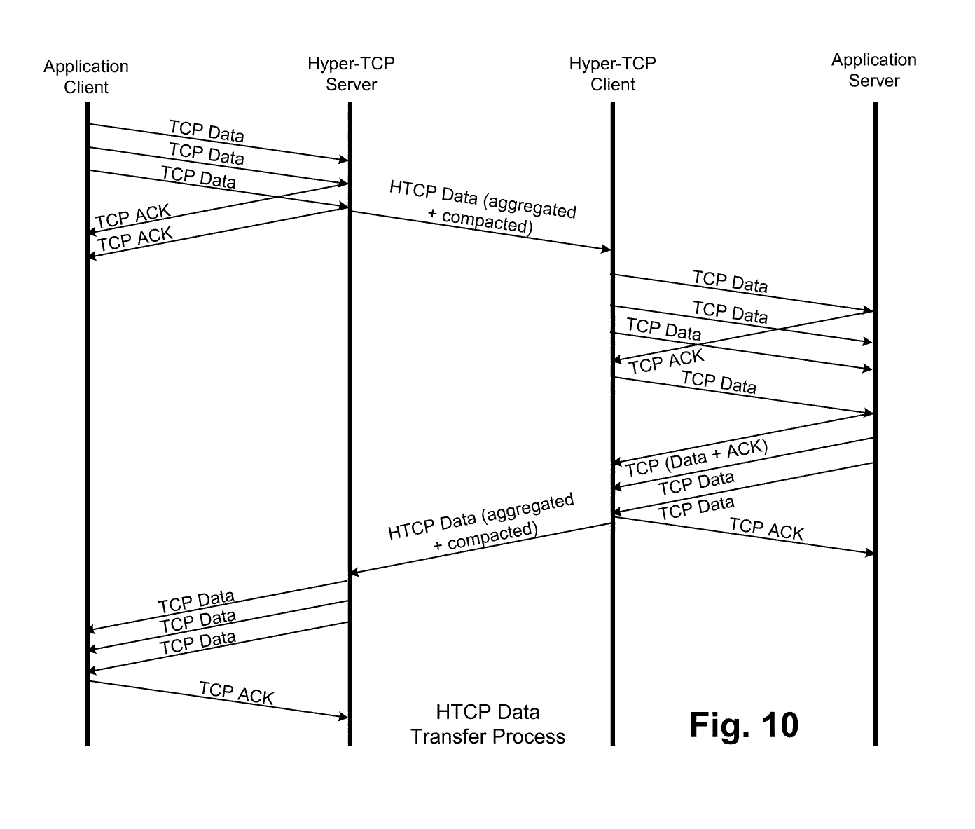

This process is illustrated in FIG. 10. Data is provided from the application client to the Hyper-TCP server, with the Hyper-TCP server ACKing the data as desired, thus terminating the connection locally at the Hyper-TCP server. The LDCM device aggregates and compacts the received data to reduce WAN traffic and sends it to the Hyper-TCP client in the other LDCM device. The receiving LDCM device uncompacts and deaggregates the data and provides it to the Hyper-TCP client, which in turn provides it to the application server, which periodically ACKs the data. Should the application server need to send data to the application client, the process is essentially reversed. By having the Hyper-TCP server and client locally respond to the received data, thus locally terminating the connections, the application server and client are not aware of the delays resulting from the WAN link between the Hyper-TCP server and client.

3) Session Termination: A received FIN/RST is transparently sent across like the session establishment packets. This is done to ensure the data integrity and consistency between the two end devices. The FIN/RST received at the Hyper-TCP server will be transparently sent across only when all the packets received prior to receiving a FIN have been locally acknowledged and sent to the Hyper-TCP client. If a FIN/RST packet has been received on the Hyper-TCP client, the packet will be transparently forwarded after all the enqueued data has been sent and acknowledged by the application server. In either direction, once the FIN has been received and forwarded, the further transfer of packets is done transparently and is not locally terminated.

This is shown in more detail in FIG. 9. The application client provides a FIN to the Hyper-TCP server. If any data has not been received by the Hyper-TCP server, the Hyper-TCP server will recover the data from the application client and provide it to the Hyper-TCP client. The Hyper-TCP server then forwards the FIN to the Hyper-TCP client, which flushes any remaining data in the Hyper-TCP client and then forwards the FIN to the application server. The application server replies with an ACK for the flushed data and then a FIN. The Hyper-TCP client then receives any outstanding data from the application server and recovers data to the application server. The ACK and the data are forwarded to the Hyper-TCP server. After the data is transferred, the Hyper-TCP client forwards the FIN to the Hyper-TCP server. The Hyper-TCP server forwards the ACK when received and flushes any remaining data to the application client. After those are complete, the Hyper-TCP server forwards the FIN and the session is closed.

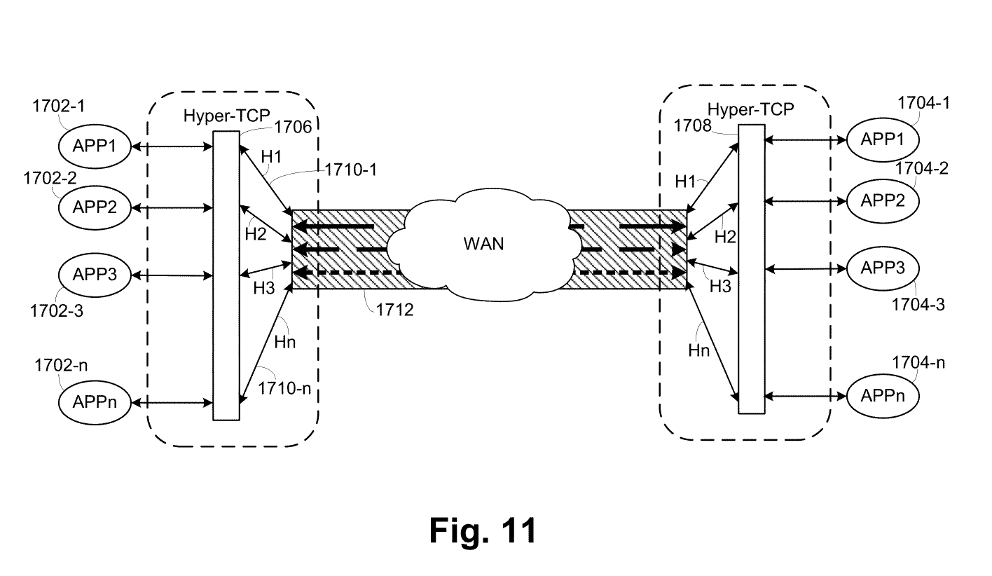

FIG. 11 illustrates the effective operation of the Hyper-TCP server and client over the CVI 1712. A series of applications 1702-1 to 1702-n are communicating with applications 1704-1 to 1704-n, respectively. The Hyper-TCP server agent 1706 cooperates with the applications 1702 while the Hyper-TCP agent 1708 cooperates with the applications 1704. In the illustration, four different Hyper-TCP sessions are shown, H1, H2, H3 and Hn 1710-1 to 1710-n, which traverse the WAN using the CVI 1712.

Flow-Based TCP

In WAN optimization products, and some other products, there is sometimes a need to tunnel multiple flows in the same TCP tunnel. Carrying multiple LAN TCP connections over one WAN TCP connection helps in reducing the number of TCP connections across the WAN but it can also introduce a head of the line blocking problem. Head of the line blocking occurs, when there is a frame loss for one of the flows and as a result of the frame loss for the one flow, other flows are not delivered until the lost frame is retransmitted. In the preferred embodiment of the invention, this problem is addressed by using stream based TCP connections where each LAN TCP connection is mapped to a stream and each stream data unit is sent with a stream identifier. TCP delivers stream data units out of order but packets in the stream data unit are always in order. CVI guarantees that data units for a stream are always delivered in order.

The head of line blocking problem and the solution for it are illustrated in FIGS. 12A-12Y. FIG. 12A illustrates a network 1500 in which two local area networks are connected through a WAN 1510. The first network includes two computer devices 1518 and 1520 which are coupled through a LAN 1514 to a CNE 1502. A router 1506 transfers the data to a WAN TCP tunnel 1512 which transmits the data to the second network. The second network includes application servers 1522 and 1524 which are coupled through a LAN 1516 to a CNE 1504. The NCE 1504 is connected to a router 1508 which can send and receive data through the WAN TCP tunnel 1512.

FIG. 12B illustrates a data stream 1530 which is being transmitted by one of the computer device 1520 or the computer device 1518 through the LAN 1514 to the CNE device 1502. FIGS. 12C-12E show how this data stream is broken down to its individual frames as it travels through the WAN TCP tunnel and how the individual frames make up a PDU. The PDU is then received by the router 1508 and transmitted through the CNE 1504 to the LAN 1516, as shown in FIG. 12F. Thus, FIGS. 12A-12F illustrate a normal transfer of data between two local networks though a TCP tunnel. FIGS. 12G-120 show a similar data transfer when head of the line blocking occurs.

FIG. 12G illustrates a data stream 1532 being transmitted through the LAN 1514 to the CNE 1502. As shown in FIG. 12H, the data stream 1532 is transferred through the router 1506 to the TCP tunnel 1512. As it travels through the TCP tunnel 1512, the data stream 1532 loses one of its frames thus turning into a data stream 1531. This is shown in FIG. 12I. The data stream 1531 then continues traveling through the TCP tunnel 1512 until it reaches the end of the tunnel (shown in FIG. 12K). There, because it is an incomplete PDU, the data stream 1531 cannot pass through the TCP tunnel 1512 to the router 1508. Instead, it remains in the tunnel until the lost frame is retransmitted. This is problematic, in particular because the stuck data stream 1531 prevents other data streams that are behind it from passing through the tunnel to the remote side. This is illustrated in FIGS. 12K-12M.

FIG. 12K shows a data stream 1534 being transmitted through the LAN 1514 to the CNE 1502 and eventually to the TCP tunnel 1512 (as shown in FIG. 12L). The data stream 1534 forms a PDU 1534 as it reaches the end of the TCP tunnel 1512 and gets stuck behind the previous data stream 1531. In prior art systems, the PDU 1534 would have to remain behind the data stream 1531 until the lost frame is retransmitted and the data stream 1531 becomes complete again. This created unnecessary delay and inefficiency in data transfer. One way to avoid this issue is to have a WAN TCP connection for each LAN TCP connection. However, such a system would require a lot of resources which also introduces inefficiency.

The preferred embodiment of the present invention introduces a method for sharing the TCP tunnel between multiple flows without having this head of the line blocking problem. The method involves allowing the data streams that are transmitted after a stuck data stream to pass through the TCP channel to the remote side without having to wait for the stuck data stream to pass through. Thus, as shown in FIG. 12N, the data stream 1534 would pass the data stream 1531 and move through the router 1508, even though data stream 1531 is still stuck. FIG. 12O illustrates how this data stream 1534 is able to pass through the CNE 1504 and LAN 1516, while the data stream 1531 is still stuck in the TCP tunnel 1512.

This is achieved by first removing out of the TCP receive queue complete but out of order PDUs. In order to do that, the boundaries of the PDUs of different data streams are preserved to determine one PDU from another. A variety of methods can be employed to preserve PDU boundaries. In one embodiment, to preserve PDU boundaries data is parsed to look for PDU/CVI headers. When out-of-order packets are received, it may not be clear where the next PDU/CVI header will be. Thus, in this embodiment every byte of payload data is searched until a header is found, and it is validated that it is in fact a header and not payload data. This method may be time consuming and not very efficient.

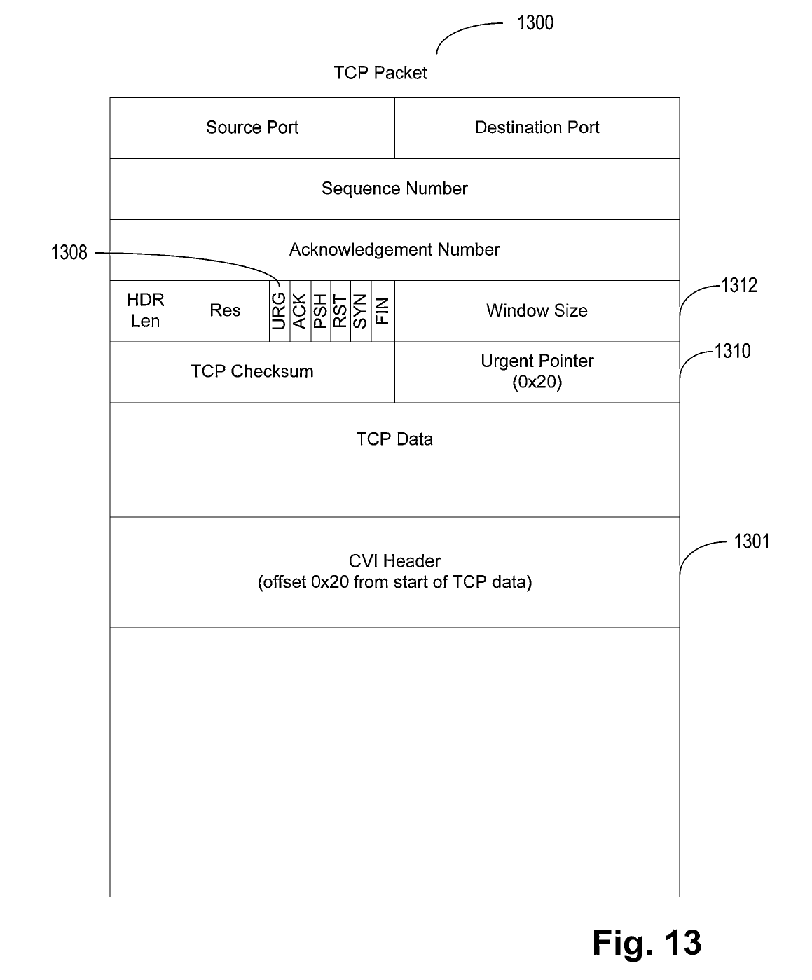

An alternative embodiment for preserving PDU boundaries involves using the urgent flag of the data stream as a pointer to the PDU boundary. In this embodiment, the urgent flag and offset are used to denote the beginning of the PDU/CVI header with a TCP segment. FIG. 13 illustrates a TCP packet having a CVI header 1301, a URG flag 1308, and an urgent pointer 1310. When a CVI header is contained within a TCP segment, as with the TCP packet 1300, the urgent pointer 1310 points to the first byte of the CVI header 1301 to preserve the boundary of the PDU. In this embodiment the CVI header contains a field of known offset and length which indicates the PDU length, which allows a determination of the start of next the PDU. When more than one PDU/CVI header is contained within a TCP Segment, the urgent pointer will point to only the first PDU header.

In one embodiment, the TCP transmit engine needs to keep a running total of the number of bytes in a PDU sent to identify when the next start of PDU is in the TCP segment. This is done through a set of counters to identify when a PDU header is in the segment. If there is a PDU header, the TCP transmit engine sets the urgent flag and sets the urgent pointer to the byte count of the previous PDU in the segment (the value can be anywhere from 0 to the MSS). If a packet does not have a start of a PDU header in it, the urgent flag is not set, indicating the entire segment is after the PDU header.

To prevent unneeded waiting and reassembly of the PDU header on the remote side, the segment size may be truncated as to include the start of the PDU header up through the entire PDU length field in a single segment. This causes some TCP segments to be smaller than the optimal MSS, but it will prevent waiting on the remote side for reassembly.

Reassembly of PDUs in TCP Receive

When a packet is received that has an urgent flag set, a check is made to verify that the PDU has enough of the header to read the PDU size. If there is enough data to read the PDU size, the size will be read, and a PDU boundary will be noted. From that point on the start of PDUs can be determined and all incoming packets processed. PDU boundaries will be determined and when an entire PDU is received, it will be immediately sent up the layer. This process allows for packets to be sent to the upper layer out of order, preventing head of line blocking.

The method of using the urgent flag as a pointer to the PDU boundary is easy to implement, but it only allows for one boundary per packet and prevents from filling the full MSS if there is a small PDU, particularly if the PDU includes jumbo frames. This is because the larger the jumbo frame, the greater the chance of multiple boundaries in a packet. This issue is addressed by using the PDU length value to calculate the start of the next PDU. This can be continued as long as segments are received in order. When an out of order segment is received, the urgent pointer is used to find the next PDU, so that the next PDU length can be obtained to continue the process. Thus, PDU boundaries can be preserved by using the urgent flag as a pointer.

The second step involved in successfully removing complete but out of order PDU's in the TCP tunnel is to open the receive window, when a complete but out of order PDU is removed out of the TCP receive queue. The size of an advertised receive window is generally restricted to two times the normal operating receive window size.

The receive window is generally opened when initially receiving out-of-order data. As out-of-order but complete PDUs are pulled out of the receive queue, however, that data is counted double towards the receive window size because the data cannot be ACKed until it can be sent up to the TCP user. To alleviate this problem, place holders are used in the receive queue to indicate data that was in the queue, but no longer exists in the queue. Thus, in the receive queue, a placeholder is inserted to indicate that data has been sent up to the user. The placeholder has byte counters for what has been sent and what is remaining to be sent to properly adjust the window sizes. This facilitates continued processing of the queue. When a segment is sent up to the application layer out of order, credits are applied to the advertised receive window for the size of the bytes sent up. Thus, the size of the data that is sent up is added in to the advertised TCP receive window. This creates a situation where the TCP receive window advertisements reflects the available size of the receive queue and the receive window is kept open for new data.

If out-of order PDUs having sizes X1, X2, X3 . . . , respectively, are pulled out of the queue, the window advertisement would be calculated as:

win_adv=max_win_size+(X1+X2+X3+ . . . )—bytes_still_in RX_queue

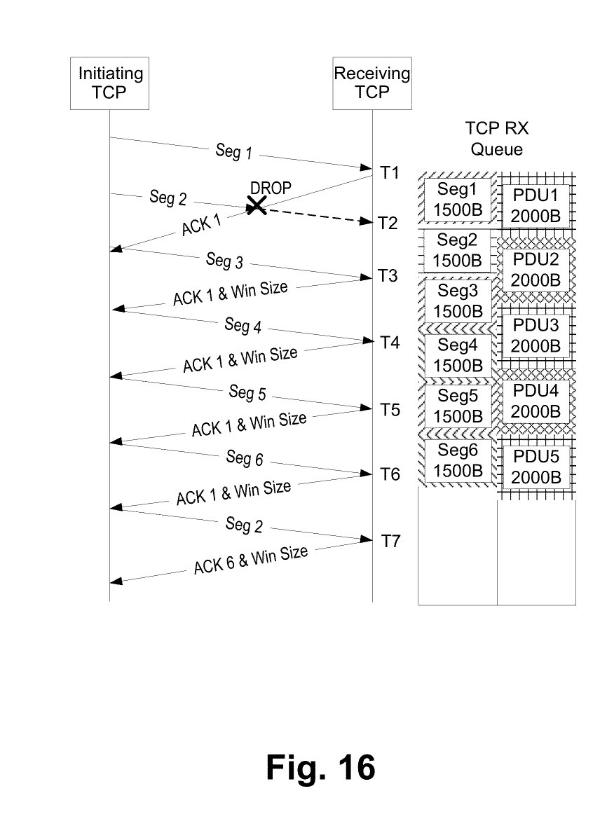

The receive window size is decreased by the amount incremented for each placeholder frame on the receive queue. This decreases the receive window size down to the normal value for when all gaps in the receive queue have been filled. FIG. 16 illustrates an example in which the RX window size is 65535 bytes, each segment is a 1500 byte segment, and the PDU byte size is 2000 for the upper layer, with segment 2 being dropped within the network.

Table 1 below represents what could be processed, and what the advertised window would be at each of the given time stamps for the above example in prior art TCP tunnel transfers. It should be noted that in the prior art TCP cases, the upper layer could not process any PDUs until after time index T6 at the point of retransmit. In addition, the window size would be steadily decreasing until the retransmit is received.

TABLE 1
Prior Art TCP Data Processing and
Window Advertisement with Loss

| | | | | Bytes to be |
|---|---|---|---|---|
| | | Data Advertised | | processed by |
| | Segment | to Upper Layer | Advertised RX | Upper Layer at |
| Time | RX | at time index | Window at time | time interval |
| Index | Number | (Bytes) | interval (Bytes) | (2 KB PDU) |
| T1 | 1 | 1500 | 64035 | 0 |
| T2 | 3 | 0 | 62535 | 0 |
| T3 | 4 | 0 | 61035 | 0 |
| T4 | 5 | 0 | 59535 | 0 |
| T5 | 6 | 0 | 58035 | 0 |
| T6 | 2 | 7500 | 64535 | 8000 |

With early credit back to the RX window when a PDU is passed along to the upper layer, the same example would progress as shown in the Table 2. As shown, in this case, at earlier time stamps the upper layer can process full PDUs. Additionally, the advertised window does not drop down as far.

TABLE 2
Optimized TCP Data Processing and
Window Advertisement with Loss

| | | | | Bytes to be |
|---|---|---|---|---|
| | | Data Advertised | | processed by |
| | Segment | to Upper Layer | Advertised RX | Upper Layer at |
| Time | RX | at time index | Window at time | time interval |
| Index | Number | (Bytes) | interval (Bytes) | (2 KB PDU) |
| T1 | 1 | 0 | 64035 | 0 |
| T2 | 3 | 0 | 62535 | 0 |
| T3 | 4 | 2000 | 63035 | 2000 |
| T4 | 5 | 0 | 61535 | 0 |
| T5 | 6 | 2000 | 62035 | 2000 |
| T6 | 2 | 4000 | 64535 | 4000 |

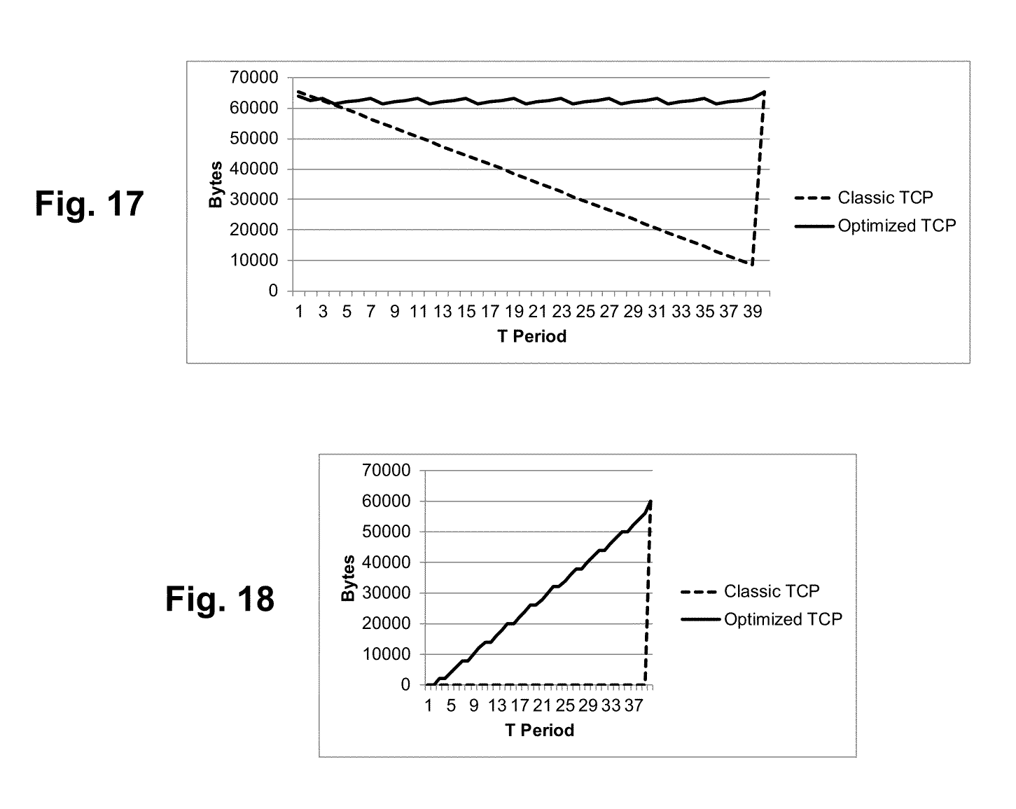

If the data in Tables 1 and 2 above is examined in a side by side comparison, it would be seen that the further removed a retransmit is from the original place it was supposed to be received, the worse the blocking is for the prior art TCPs. Table 3 below shows a side by side comparison based on the following assumptions:
Starting window size of 65535
Latency of 10 ms
500 Mbit/s connection speed
Assumption of non-blocking PDUs. Upper layer is responsible for any blocking that might occur due to PDUs being on the same stream.
   Given these assumptions, there will be roughly 40 segments sent in the time between receiving the out of order ACK, and the time the retransmit is received. This represents what a typical network environment would encounter. FIG. 17 illustrates the windows sizes for the two cases while FIG. 18 illustrates the bytes processed by the upper layer for the two cases.

TABLE 3
Optimized TCP vs. Prior Art TCP in a Typical Network Scenario with Loss

| | | Classic TCP | | | Optimized TCP | | | |
|---|---|---|---|---|---|---|---|---|
| | | Data | | | Data | | | |
| | | Sent To | | Size that | Sent To | | Size that | |
| | | Upper | | can be | Upper | | can be | |
| | | Layer | Advertised | processed | Layer | Advertised | processed | Sum |
| | Segment | at time | RX | by Upper | at time | RX | by Upper | processed |
| Time | RX | index | Window | layer | index | Window | layer | by upper |
| Index | Number | (Bytes) | (Bytes) | (Bytes) | (Bytes) | (Bytes) | (Bytes) | layer |
| T1 | 1 | 1500 | 65535 | 0 | 0 | 64035 | 0 | 0 |
| T2 | 3 | 0 | 64035 | 0 | 0 | 62535 | 0 | 0 |
| T3 | 4 | 0 | 62535 | 0 | 2000 | 63035 | 2000 | 2000 |
| T4 | 5 | 0 | 61035 | 0 | 0 | 61535 | 0 | 2000 |
| T5 | 6 | 0 | 59535 | 0 | 2000 | 62035 | 2000 | 4000 |
| T6 | 7 | 0 | 58035 | 0 | 2000 | 62535 | 2000 | 6000 |
| T7 | 8 | 0 | 56535 | 0 | 2000 | 63035 | 2000 | 8000 |
| T8 | 9 | 0 | 55035 | 0 | 0 | 61535 | 0 | 8000 |
| T9 | 10 | 0 | 53535 | 0 | 2000 | 62035 | 2000 | 10000 |
| T10 | 11 | 0 | 52035 | 0 | 2000 | 62535 | 2000 | 12000 |
| T11 | 12 | 0 | 50535 | 0 | 2000 | 63035 | 2000 | 14000 |
| T12 | 13 | 0 | 49035 | 0 | 0 | 61535 | 0 | 14000 |
| T13 | 14 | 0 | 47535 | 0 | 2000 | 62035 | 2000 | 16000 |
| T14 | 15 | 0 | 46035 | 0 | 2000 | 62535 | 2000 | 18000 |
| T15 | 16 | 0 | 44535 | 0 | 2000 | 63035 | 2000 | 20000 |
| T16 | 17 | 0 | 43035 | 0 | 0 | 61535 | 0 | 20000 |
| T17 | 18 | 0 | 41535 | 0 | 2000 | 62035 | 2000 | 22000 |
| T18 | 19 | 0 | 40035 | 0 | 2000 | 62535 | 2000 | 24000 |
| T19 | 20 | 0 | 38535 | 0 | 2000 | 63035 | 2000 | 26000 |
| T20 | 21 | 0 | 37035 | 0 | 0 | 61535 | 0 | 26000 |
| T21 | 22 | 0 | 35535 | 0 | 2000 | 62035 | 2000 | 28000 |
| T22 | 23 | 0 | 34035 | 0 | 2000 | 62535 | 2000 | 30000 |
| T23 | 24 | 0 | 32535 | 0 | 2000 | 63035 | 2000 | 32000 |
| T24 | 25 | 0 | 31035 | 0 | 0 | 61535 | 0 | 32000 |
| T25 | 26 | 0 | 29535 | 0 | 2000 | 62035 | 2000 | 34000 |
| T26 | 27 | 0 | 28035 | 0 | 2000 | 62535 | 2000 | 36000 |
| T27 | 28 | 0 | 26535 | 0 | 2000 | 63035 | 2000 | 38000 |
| T28 | 29 | 0 | 25035 | 0 | 0 | 61535 | 0 | 38000 |
| T29 | 30 | 0 | 23535 | 0 | 2000 | 62035 | 2000 | 40000 |
| T30 | 31 | 0 | 22035 | 0 | 2000 | 62535 | 2000 | 42000 |
| T31 | 32 | 0 | 20535 | 0 | 2000 | 63035 | 2000 | 44000 |
| T32 | 33 | 0 | 19035 | 0 | 0 | 61535 | 0 | 44000 |
| T33 | 34 | 0 | 17535 | 0 | 2000 | 62035 | 2000 | 46000 |
| T34 | 35 | 0 | 16035 | 0 | 2000 | 62535 | 2000 | 48000 |
| T35 | 36 | 0 | 14535 | 0 | 2000 | 63035 | 2000 | 50000 |
| T36 | 37 | 0 | 13035 | 0 | 0 | 61535 | 0 | 50000 |
| T37 | 38 | 0 | 11535 | 0 | 2000 | 62035 | 2000 | 52000 |
| T38 | 39 | 0 | 10035 | 0 | 2000 | 62535 | 2000 | 54000 |
| T39 | 40 | 0 | 8535 | 0 | 2000 | 63035 | 2000 | 56000 |
| T40 | 2 | 58500 | 65535 | 60000 | 4000 | 65535 | 4000 | 60000 |

The disclosed method of manipulating the receive window size keeps the sending side from running out of transmit window size and stopping transmission of new data when the receive side is able to pull out-of-order data from the RX queue. This helps reduce the amount of head-of-line-blocking when multiple flows share the same WAN TCP connection.

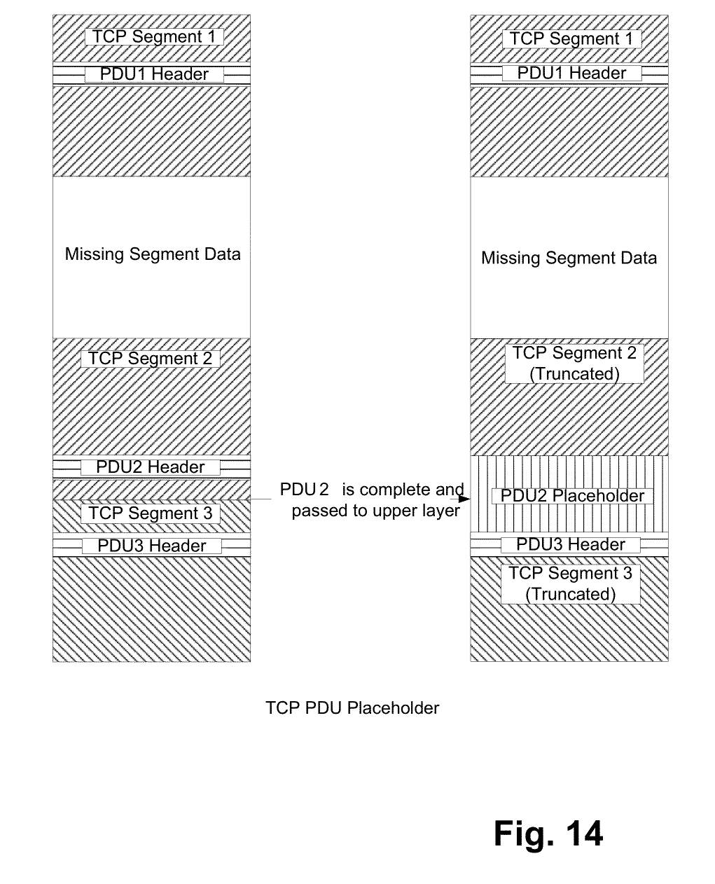

As shown in FIG. 14, in one embodiment, the TCP Segment information for the segment before and after the PDU that was sent up is truncated to no longer contain the PDU information for the one that was passed up.

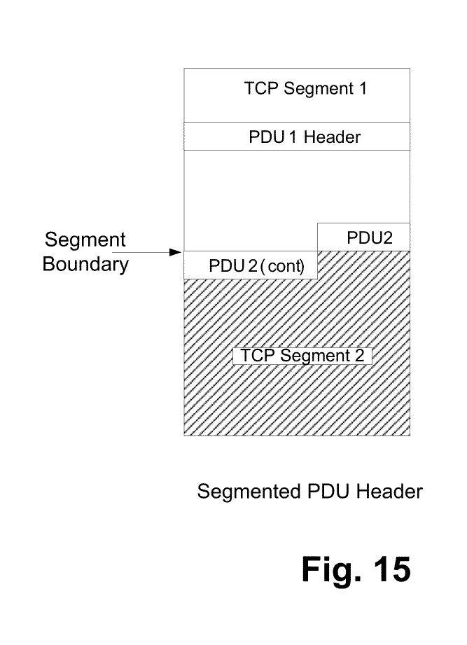

FIG. 15 illustrates a situation in which a received PDU header is on a segment boundary. As shown in FIG. 15, PDU 2 in on a segment boundary between TCP segment 1 and TCP segment 2. Thus a part of the PDU 2 header is in TCP segment 1 and a part of it is in TCP Segment 2. The system generally attempts to avoid this situation on the transmit side, but it may still occur if other network devices are in the middle. To address this issue, the following calculation is made:

if ((segment size−urgent pointer−length offset−length size)>0){/*length is not segmented*/}

Once the entire portion of the length field is received, the length of the PDU is determined and processed on the queue as normal.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A network device comprising:
a port for connection to a wide area network (WAN) carrying TCP traffic;
a TCP receive queue coupled to said port to which first and second PDUs are added;
a PDU removal logic coupled to said TCP receive queue to pull PDUs from said TCP receive queue, wherein if the first PDU is incomplete and the second PDU is complete, said PDU removal logic pulls the second PDU prior to the first PDU being complete; and
a TCP receive window advertisement logic coupled to said PDU removal logic and said port to provide a frame to the WAN which increases a TCP advertised receive window size by the size of the second PDU when the second PDU is pulled before the first PDU is complete.

2. The network device of claim 1, wherein the boundaries of each of the first and the second PDUs are preserved in said TCP receive queue.

3. The network device of claim 2, wherein the boundaries of each of the first and the second PDUs are preserved by using an urgent flag in each of the PDUs to point to a PDU boundary.

4. The network device of claim 3, wherein the urgent pointer is pointed to the first byte of a PDU header.

5. The network device of claim 2, wherein the boundaries of each of the first and the second PDUs are preserved by parsing the first and the second PDUs to look for PDU headers.

6. The network device of claim 1, wherein a placeholder is placed in the TCP receive queue for the second PDU when the second PDU is pulled.

7. The network device of claim 6, wherein the placeholder has a byte counter for any PDU that is pulled out of the TCP receive queue.

8. The network device of claim 6, wherein the placeholder has a byte counter for any PDU that is still remaining in the TCP receive queue.

9. The network device of claim 1, wherein when the first PDU is complete, said PDU removal logic pulls the first PDU and said TCP receive window advertisement logic decreases the TCP advertised receive window by the size of the second PDU when the first PDU is pulled.

10. A method comprising:
receiving from a wide area network (WAN) connection a plurality of two or more PDUs by a TCP receive queue, wherein at least one of the PDUs is incomplete and one or more of the remaining PDUs are complete;
pulling the complete PDUs out of the TCP receive queue prior to completing a preceding PDU; and
providing a TCP receive window advertisement which increases a TCP advertised receive window size by the size of a pulled PDU each time a complete PDU is pulled out of the TCP receive queue prior to a preceding PDU being completed.

11. The method of claim 10, further comprising preserving the boundaries of each of the plurality of the PDUs in the TCP receive queue.

12. The method of claim 11, wherein the boundaries of each of the PDUs are preserved by using an urgent flag in each of the PDUs to point to a PDU boundary.

13. The method of claim 12, further comprising pointing the urgent pointer to the first byte of a PDU header.

14. The method of claim 11, wherein the boundaries of each of the PDUs are preserved by parsing the PDUs to look for PDU headers.

15. The method of claim 10, further comprising placing a placeholder in the TCP receive queue for each complete PDU that is pulled.

16. The method of claim 15, wherein the placeholder has a byte counter for any PDU that is pulled of the TCP receive queue.

17. The method of claim 15, wherein the placeholder has a byte counter for any PDU that is still remaining in the TCP receive queue.

18. The method of claim 10, further comprising pulling the previously incomplete PDU from the TCP receive queue, when the previously incomplete PDU is complete and decreasing the TCP advertised receive window size by the size of the PDUs following the now complete PDU which have been previously pulled, when the now complete PDU is pulled.

19. A network device comprising:
a port for connection to a wide area network (WAN) carrying TCP traffic;
a TCP receive queue coupled to said port to which a plurality of PDUs are added;
a PDU removal logic coupled to said TCP receive queue to pull PDUs from said TCP receive queue, wherein if one of the plurality of PDUs is incomplete and one or more of the plurality of PDUs following the incomplete PDU are complete, said PDU removal logic pulls the one or more of the plurality of complete PDUs prior to the preceding incomplete PDU becoming complete; and
a TCP receive window advertisement logic coupled to said PDU removal logic and said port to provide a frame to the WAN which increases a TCP advertised receive window size by the size of a pulled PDU each time a complete PDU is pulled out of the TCP receive queue prior to a preceding PDU being completed.

20. The network device of claim 19, wherein the boundaries of each of the PDUs in said TCP receive queue are preserved.

21. The network device of claim 20, wherein the boundaries of each of the PDUs are preserved by using an urgent pointer in each of the PDUs to point to a PDU boundary.

22. The network device of claim 21, wherein the urgent pointer is pointed to the first byte of a PDU header.

23. The network device of claim 20, wherein the boundaries of each of the PDUs are preserved by parsing the PDUs to look for PDU headers.

24. The network device of claim 19, wherein a placeholder is placed in the TCP receive queue for each complete PDU when a complete PDU is pulled.

25. The network device of claim 24, wherein the placeholder has a byte counter for any PDU that is pulled out of the TCP receive queue.

26. The network device of claim 24, wherein the placeholder has a byte counter for any PDU that is still remaining in the TCP receive queue.

27. A method comprising:
receiving a first and a second PDU by a TCP receive queue, the first PDU being incomplete and the second PDU being complete;
pulling the second PDU out of the TCP receive queue prior to the first PDU being complete; and
providing a TCP receive window advertisement which increases a TCP advertised receive window size by the size of the second PDU when the second PDU is pulled out of the TCP receive queue prior to the first PDU being complete.

28. The method of claim 27, further comprising preserving the boundaries of each of the first and the second PDUs in the TCP receive queue.

29. The method of claim 28, wherein the boundaries of each of the first and the second PDUs are preserved by using an urgent flag in each of the PDUs to point to a PDU boundary.

30. The method of claim 29, further comprising pointing the urgent pointer to the first byte of a PDU header.

31. The method of claim 28, wherein the boundaries of each of the first and the second PDUs are preserved by parsing the first and the second PDUs to look for PDU headers.

32. The method of claim 27, further comprising placing a placeholder in the TCP receive queue for the second PDU when the second PDU is pulled.

33. The method of claim 32, wherein the placeholder has a byte counter for any PDU that is pulled of the TCP receive queue.

34. The method of claim 32, wherein the placeholder has a byte counter for any PDU that is still remaining in the TCP receive queue.

35. The method of claim 27, further comprising pulling the first PDU out of the TCP receive queue when the first PDU becomes complete and decreasing the TCP receive window size by the size of the second PDU when the first PDU is pulled.
